(19) United States
(12) Patent Application Publication
(10) Pub. No.: US 2015/0173133 A1
(43) Pub. Date: Jun. 18, 2015

(54) LIGHTING DEVICE AND LUMINAIRE

(71) Applicant: Panasonic Intellectual Property Management Co., Ltd., Osaka (JP)

(72) Inventors: Keisuke SEKI, Osaka (JP); Takeshi KAMOI, Kyoto (JP); Daisuke YAMAHARA, Osaka (JP)

(21) Appl. No.: 14/572,990

(22) Filed: Dec. 17, 2014

(30) Foreign Application Priority Data
Dec. 18, 2013 (JP) 2013-261624
Dec. 19, 2013 (JP) 2013-262717

(51) Int. Cl. H05B 33/08

(52) U.S. Cl. CPC H05B 33/08

(57) ABSTRACT

A lighting device includes a constant-current circuit, a smoothing capacitor, a bypass circuit, a detection unit, and a bypass control unit. The constant-current circuit supplies a constant current to a plurality of solid-state light-emitting elements connected in series. The smoothing capacitor is connected between output terminals of the constant-current circuit. The bypass circuit is connected in parallel to one or more of the plurality of solid-state light-emitting elements. The detection unit detects whether the one or more solid-state light-emitting elements are open-circuited. When the detection unit detects that at least one of the one or more solid-state light-emitting elements is open-circuited, the bypass control unit discharges the smoothing capacitor during a discharge period to then bypass the one or more solid-state light-emitting elements through the bypass circuit.

### CROSS-REFERENCE TO RELATED APPLICATION

This application claims the benefit of priorities of Japanese Patent Application Nos. 2013-261624, filed on Dec. 18, 2013 and 2013-262717, filed on Dec. 19, 2013, the entire contents of which are hereby incorporated by reference.

### TECHNICAL FIELD

The present invention relates to a lighting device of a solid-state light-emitting element such as an LED (light-emitting diode), and a luminaire having the lighting device.

### BACKGROUND ART

A solid-state light-emitting element such as an LED is attracting attention as a light source for a variety of products since it is smaller, more efficient, and lasts longer.

Examples of products using LEDs as a light source include a luminaire. The number of LEDs used in a luminaire is determined based on a desired brightness. Typically, a number of LEDs are used for a single luminaire. When a number of LEDs are used in a luminaire, the LEDs may be connected in series to one another. In this arrangement, the same current is supplied to the LEDs, and accordingly unevenness in brightness of the LEDs can be suppressed.

For the arrangement in which LEDs are connected in series to one another, if one of the LEDs has an open-circuit failure, current supply is stopped for all of the LEDs, so that the other normal LEDs are not lit as well. In order to address this problem, a technique is known, in which a bypass circuit is connected in parallel to each of the LEDs, and the bypass circuit is turned on when an open-circuit failure occurs in the corresponding LED to thereby supply current to the other normal solid-state light-emitting elements (see, e.g., Japanese Unexamined Patent Application Publication Nos. 2005-310999, 2008-204866, 2003-208993, and 2009-038247).

For such a luminaire, however, excessive current may flow in the other normal LEDs when the bypass circuit is operated. As a result, the normal LEDs may deteriorate or fail.

For example, in the disclosure of Japanese Unexamined Patent Application Publication No. 2009-038247, a bypass circuit is connected in parallel to each of LEDs connected in series, and if an increase in the voltage across an LED having an open-circuit failure is detected, a bypass switch in a corresponding bypass circuit is turned on. In this instance, however, immediately after the bypass switch is turned on, excessive current flows in the other LEDs having no open-circuit failure and in the corresponding bypass circuit. Therefore, in the above disclosure, normal LEDs may deteriorate or fail. In order to prevent the LEDs from deteriorating or failing, the LEDs or the like need to be robust to stress due to such excessive current, causing the cost and size to be increased.

Hereinafter, such a problem will be described in more detail with reference to FIGS. 1A and 1B and FIG. 2.

FIG. 1A is a circuit diagram of a luminaire having bypass circuits. The luminaire shown in FIG. 1A includes: light-emitting elements 103a and 103b connected in series; a bypass circuit 104a connected in parallel to the light-emitting element 103a; a bypass circuit 104b connected in parallel to the light-emitting element 103b; a constant-current circuit 101 for supplying constant current to the light-emitting elements 103a and 103b; and a smoothing capacitor 102 connected between output terminals of the constant-current circuit 101. The light-emitting elements 103a and 103b are, e.g., LEDs.

In this luminaire, if the light-emitting element 103b has an open-circuit failure, the bypass circuit 104b is turned on as shown in FIG. 1B. By doing so, current is supplied to the light-emitting element 103a. As such, the luminaire can prevent that all of the light-emitting elements are lit out when one of them has an open-circuit failure.

Further, in this luminaire, the output voltage VC from the constant-current circuit 101 is monitored, for example, and it is detected that the light-emitting element 103 or 103b has an open-circuit failure if the voltage VC rises above a predetermined voltage.

In this regard, the present inventors have found out that such a luminaire has the following problem. FIG. 2 shows graphs of the voltage VC versus time and a current I flowing in the normal light-emitting element 103a versus time, in the case where an open-circuit failure occurs.

Before time t1 at which an open-circuit failure occurs, the voltage VC is equal to the sum of forward voltages of the two light-emitting elements 103a and 103b (2×Vf). When an open-circuit failure occurs at time t1, no current flows in the normal light-emitting element 103a and the voltage VC rises. At time t2, the voltage VC rises above a predetermined voltage (i.e., VC>2×Vf). Accordingly, the bypass circuit 104b is turned on.

As the bypass circuit 104b is turned on, the voltage VC decreases up to a voltage equal to the forward voltage Vf of the normal light-emitting element 103a. However, at the moment when the bypass circuit 104b is turned on, the voltage VC is higher than the voltage 2×Vf, and electric charges corresponding to this voltage have been accumulated in the smoothing capacitor 102. Therefore, at the moment when the bypass circuit 104b is turned on, electric charges accumulated in the smoothing capacitor 102, which correspond to a difference voltage (>Vf) between the voltage (>2×Vf) and the forward voltage Vf (i.e., electric charges which correspond to the forward voltage Vf of the light-emitting element 103b having the open-circuit failure) flow in the normal light-emitting element 103a at a burst (from time t2 to time t3).

As such, excessive current may flow in the normal light-emitting element 103a so that the normal light-emitting element 103a may deteriorate or break down. In addition, when excessive current flows in the light-emitting element 103a, the bypass circuit 104a may be erroneously turned on.

In order to suppress excessive current from flowing in the normal light-emitting element 103a, the bypass circuit 104b having a forward voltage equal to the forward voltage of the light-emitting element 103b may be provided. However, this approach may cause another problem in that the bypass circuit 104b has more power loss.

As a technology to suppress such excessive current, there is known a technique in which a voltage drop unit is provided in a bypass circuit (see, e.g., International Publication No. WO 2012/005239). According to this reference, a resistor is provided in a bypass circuit as a voltage drop unit, so that it reduces current flowing immediately after a bypass switch in the bypass circuit is turned on, thereby suppressing stress exerted on LEDs or the like.

In this approach, however, the power loss is continuously generated by the voltage drop unit after connecting two ends of the LED having the open-circuit failure.

### SUMMARY OF THE INVENTION

In view of the above, the present invention provides a lighting device, with solid-state light-emitting elements connected in series and bypass circuits, capable of suppressing excessive current from flowing in normal light-emitting elements at the moment when a bypass circuit is turned on.

In accordance with an aspect of the present invention, there is provided a lighting device including: a constant-current circuit configured to supply a constant current to a plurality of solid-state light-emitting elements connected in series; a smoothing capacitor connected between output terminals of the constant-current circuit; a bypass circuit connected in parallel to one or more of the plurality of solid-state light-emitting elements, the bypass circuit configured to bypass the one or more solid-state light-emitting elements; a detection unit configured to detect whether the one or more solid-state light-emitting elements are open-circuited; and a bypass control unit configured to, when the detection unit detects that at least one of the one or more solid-state light-emitting elements is open-circuited, discharge the smoothing capacitor during a discharge period to then bypass the one or more solid-state light-emitting elements through the bypass circuit.

Further, during the discharge period, the smoothing capacitor may be discharged until a voltage across the smoothing capacitor becomes smaller than a sum of forward voltages of the plurality of solid-state light-emitting elements.

Further, during the discharge period, the smoothing capacitor may be discharged until the voltage across the smoothing capacitor becomes smaller than a sum of forward voltages of other solid-state light-emitting elements than the one or more solid-state light-emitting elements among the plurality of solid-state light-emitting elements.

Further, during the discharge period, the bypass control unit may stop the constant-current circuit or may reduce a value of the constant current supplied from the constant-current circuit.

Further, the lighting device may further include a discharge circuit connected in parallel to the smoothing capacitor, wherein, during the discharge period, the bypass control unit may turn on the discharge circuit to discharge the smoothing capacitor.

Further, the bypass control unit may include a comparator to compare a voltage across the smoothing capacitor with a predetermined reference voltage, and the bypass control unit may terminate the discharge period when the voltage across the smoothing capacitor becomes lower than the reference voltage, and may bypass the one or more solid-state light-emitting elements through the bypass circuit.

Further, after the detection unit detects that said at least one of the one or more solid-state light-emitting elements is open-circuited, the bypass control unit may terminate the discharge period after a predetermined time period has elapsed and may bypass the one or more solid-state light-emitting elements through the bypass circuit.

Further, the discharge period may be longer than a time constant of a discharge path through which the smoothing capacitor is discharged.

Further, the constant-current circuit may be a DC-to-DC converter that is supplied with a current from a DC power source, and the constant-current circuit may include: a switching element; an inductor through which the current from the DC power source flows when the switching element is turned on; a diode through which a current discharged from the inductor is supplied to the plurality of solid-state light-emitting elements; and a control unit for controlling on and off of the switching element.

In accordance with another aspect of the present invention, there is provided a lighting device including: a constant-current circuit configured to supply a constant current to a plurality of solid-state light-emitting elements connected in series; a capacitor circuit connected in parallel to one or more of the plurality of solid-state light-emitting elements, the capacitor circuit including a capacitor; a bypass switch circuit connected in parallel to the one or more solid-state light-emitting elements and to the capacitor circuit, the bypass switch circuit including a bypass switch; and a current detection unit configured to measure a current flowing through the capacitor, wherein the current detection unit turns on the bypass switch when the measured current exceeds a predetermined threshold.

Further, the capacitor circuit may further include a resistor connected in series to the capacitor, and the current detection unit may measure the current based on a voltage across the resistor.

Further, the current detection unit may include a resistor-capacitor filter to attenuate high-frequency components in the current.

Further, the bypass switch circuit may further include an impedance element connected in series to the bypass switch.

Further, the constant-current circuit may be a DC-to-DC converter that is supplied with current from a DC power source, and the constant-current circuit may include: a switching element; a control circuit that outputs a signal to control on and off of the switching element; an inductive element through which the current from the DC power source flows when the switching element is turned on; and a diode through which a current discharged from the inductive element is supplied to the plurality of solid-state light-emitting elements.

Further, the current detection unit may detect a DC component in the current flowing through the capacitor.

Further, the constant-current circuit may be driven in a boundary current mode, and the predetermine threshold may be larger than a value of the constant current supplied from the constant-current circuit and may be equal to or less than two times the value.

In accordance with yet another aspect of the present invention, there is provided a luminaire including: the lighting device described above; and the plurality of solid-state light-emitting elements that receive the constant current from the lighting device.

In accordance with the aspects of the present invention, in a lighting device with solid-state light-emitting elements connected in series and bypass circuits, the lighting device can suppress excessive current from flowing in normal light-emitting elements at the moment when a bypass circuit is turned on.

Accordingly, it is possible to prevent the normal light-emitting elements from deteriorating or failing.

### BRIEF DESCRIPTION OF THE DRAWINGS

The objects and features of the present invention will become apparent from the following description of embodiments, given in conjunction with the accompanying drawings, in which:

FIG. 1A is a circuit diagram of a luminaire having bypass circuits;

FIG. 1B is a circuit diagram showing an operation example of a luminaire having bypass circuits;

FIG. 2 is a timing chart showing a voltage and a current when a bypass circuit operates;

FIG. 3 is a schematic circuit diagram of a lighting device according to a first embodiment;

FIG. 4 is a circuit diagram showing a detailed configuration example of the lighting device according to the first embodiment;

FIG. 5 is a circuit diagram showing a configuration example of a bypass control unit according to the first embodiment;

FIG. 6 is a timing chart of the lighting device according to the first embodiment;

FIG. 7 is a circuit diagram showing a configuration example of a lighting device according to a second embodiment;

FIG. 8 is a circuit diagram showing a configuration example of a bypass control unit according to the second embodiment;

FIG. 9 is a timing chart of the lighting device according to the second embodiment;

FIG. 10 is a circuit diagram showing a configuration example of a lighting device according to a modification of the second embodiment;

FIG. 11 is a circuit diagram showing a configuration example of a bypass control unit according to the modification of the second embodiment;

FIG. 12 is a circuit diagram showing a configuration example of a lighting device according to a third embodiment;

FIG. 13 is a circuit diagram showing a configuration example of a bypass control unit according to the third embodiment;

FIG. 14 is a timing chart of the lighting device according to the third embodiment;

FIG. 15A is a circuit diagram showing a configuration example of a timer according to the third embodiment;

FIG. 15B is a timing chart of the timer according to the third embodiment;

FIG. 16 is a circuit diagram showing a configuration example of a lighting device according to a fourth embodiment;

FIG. 17A is a flowchart for illustrating processes by in an MCU according to the fourth embodiment;

FIG. 17B is a flowchart for illustrating processes by in an MCU according to a modification of the fourth embodiment;

FIG. 18 is a circuit diagram showing a configuration example of light-emitting elements according to a modification of the embodiments;

FIG. 19 is a circuit diagram showing a configuration example of a constant-current circuit according to the exemplary embodiments;

FIG. 20 is a circuit diagram showing a configuration example of a control unit according to the embodiments;

FIG. 21 is a circuit diagram showing another configuration example of a constant-current circuit according to the embodiments;

FIG. 22 is a circuit diagram showing another configuration example of a constant-current circuit according to the embodiments;

FIG. 23 is a circuit diagram showing another configuration example of a constant-current circuit according to the embodiments;

FIG. 24 is a circuit diagram of a lighting device 1a according to a fifth embodiment;

FIG. 25 shows waveforms of current and voltage of elements in the lighting device 1a according to the fifth embodiment;

FIG. 26 shows enlarged waveforms of current and voltage of elements in the lighting device 1a according to the fifth embodiment;

FIG. 27 shows enlarged waveforms of current and voltage of elements in the lighting device 1a according to the fifth embodiment;

FIG. 28 is a circuit diagram of a lighting device 1b according to a sixth embodiment;

FIG. 29 shows voltage waveforms of elements in the lighting device 1b according to the sixth embodiment;

FIG. 30 is a circuit diagram of a lighting device 1c according to a seventh embodiment;

FIG. 31 shows current waveforms of elements in the lighting device 1a according to the fifth embodiment and the lighting device 1c according to the seventh embodiment;

FIG. 32 is a circuit diagram of a lighting device 1d according to an eighth embodiment;

FIG. 33 is a circuit diagram of a lighting device 1e according to a ninth embodiment;

FIG. 34 is an external view of a luminaire according to a tenth embodiment.

FIG. 35 is an external view of a luminaire according to the tenth embodiment; and

FIG. 36 is an external view of a luminaire according to the tenth embodiment.

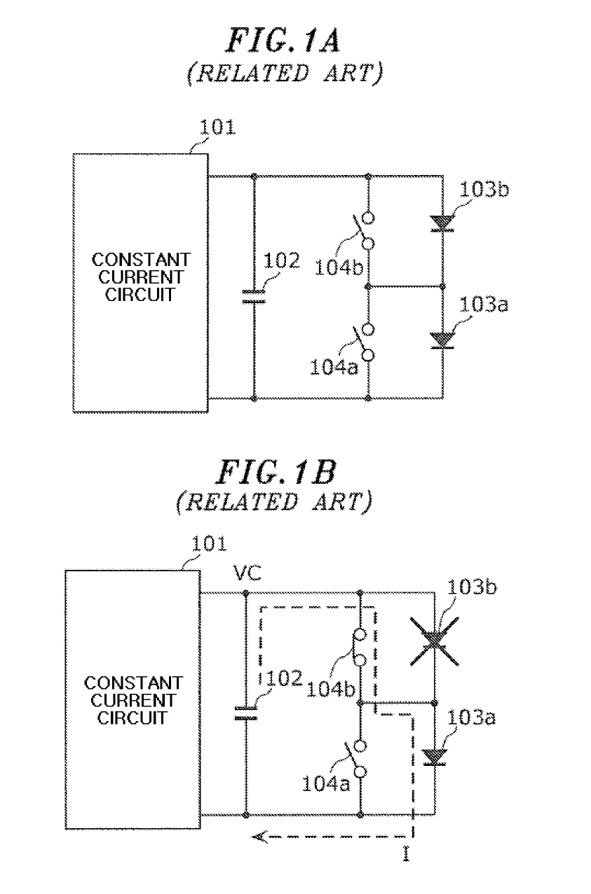

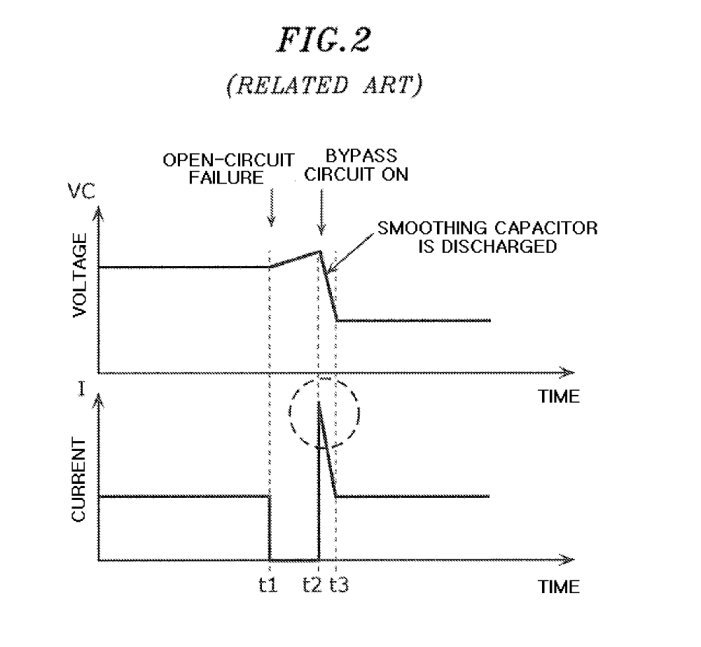

### DETAILED DESCRIPTION

Hereinafter, embodiments of the present invention will be described with reference to the accompanying drawings.

In the following descriptions, embodiments to be described below are all to provide preferable examples of the present invention. Therefore, the numerical values, shapes, materials, elements, arrangement of elements, connection manner and the like are merely illustrative but are not limited to those to be suggested in the following embodiments. Accordingly, among the elements described in the embodiments, those not recited in the broadest independent claims are meant to be selective elements. In addition, the drawings are schematic views and are not strictly depicted.

### First Embodiment

According to the first embodiment, when an open-circuit failure has occurred, a luminaire releases electric charges accumulated in a smoothing capacitor and then turns on a bypass circuit. Specifically, the luminaire releases electric charges accumulated in the smoothing capacitor by interrupting a constant-current circuit for a predetermined time period after the open-circuit failure has occurred. By doing so, it is possible to suppress excessive current flowing in normal light-emitting elements when the bypass circuit is turned on.

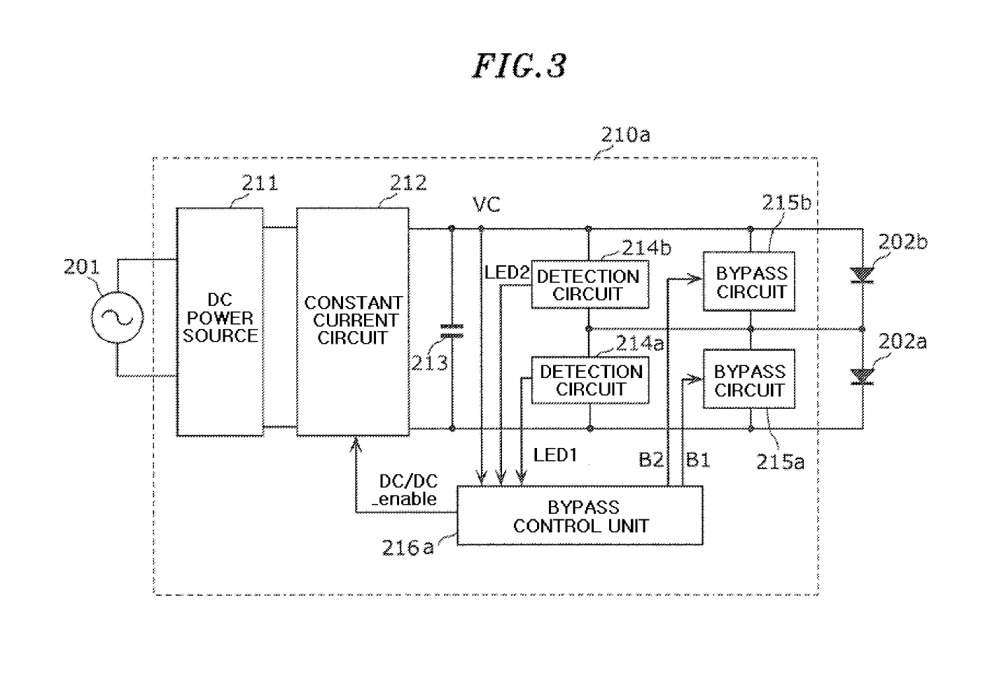

FIG. 3 is a circuit diagram of a lighting device 210a according to the first embodiment of the present invention.

The lighting device 210a lights solid-state light-emitting elements connected in series to each other, e.g., LEDs 202a and 202b, by using power from a commercial power source 201. The lighting device 210a includes a DC power source 211, a constant-current circuit 212, a smoothing capacitor 213, a detection circuits 214a and 214b, bypass circuits 215a and 215b, and a bypass control unit 216a.

The DC power source 211 is a circuit to convert AC power supplied from the commercial power source 201 into DC power, e.g., an AC-to-DC converter.

The constant-current circuit 212 is a circuit to generate a constant current by using DC power supplied from the DC power source 211, e.g., a DC-to-DC converter. The constant current generated in the constant-current circuit 212 is supplied to the LEDs 202a and 202b.

The smoothing capacitor 213 is connected between output terminals of the constant-current circuit 212. The smoothing capacitor 213 is a capacitive element to smoothen the constant current generated by the constant-current circuit 212. Although the smoothing capacitor 213 is disposed outside the constant-current circuit 212 in FIG. 3, it may be incorporated in the constant-current circuit 212.

The detection circuit 214a detects whether the LED 202a is open-circuited. In other words, the detection circuit 214a detects whether the LED 202a has an open-circuit failure. Likewise, the detection circuit 214b detects whether the LED 202b is open-circuited, i.e., whether the LED 202b has an open-circuit failure.

The bypass circuit 215a is connected in parallel to the LED 202a and is for bypassing the LED 202a. For example, the bypass circuit 215a includes a switching element connected in parallel to the LED 202a. When the bypass circuit 215a is turned on, two ends of the LED 202a are short-circuited.

Likewise, the bypass circuit 215b is connected in parallel to the LED 202b and is for bypassing the LED 202b. For example, the bypass circuit 215b includes a switching element connected in parallel to the LED 202b. When the bypass circuit 215b is turned on, two ends of the LED 202b are short-circuited.

The bypass control unit 216a controls the bypass circuits 215a and 215b and the constant-current circuit 212 based on the results detected by the detection circuits 214a and 214b. Specifically, the bypass control unit 216a turns on the bypass circuit 215a if the detection circuit 214a detects an open-circuit failure in the LED 202a. Further, the bypass control unit 216a turns on the bypass circuit 215b if the detection circuit 214b detects an open-circuit failure in the LED 202b. Furthermore, if an open-circuit failure has detected, the bypass control unit 216a interrupts the constant-current circuit 212 for a predetermined discharge period, and then turns on the bypass circuit 215a or 215b. By doing so, electric charges accumulated in the smoothing capacitor 213 are released during the discharge period.

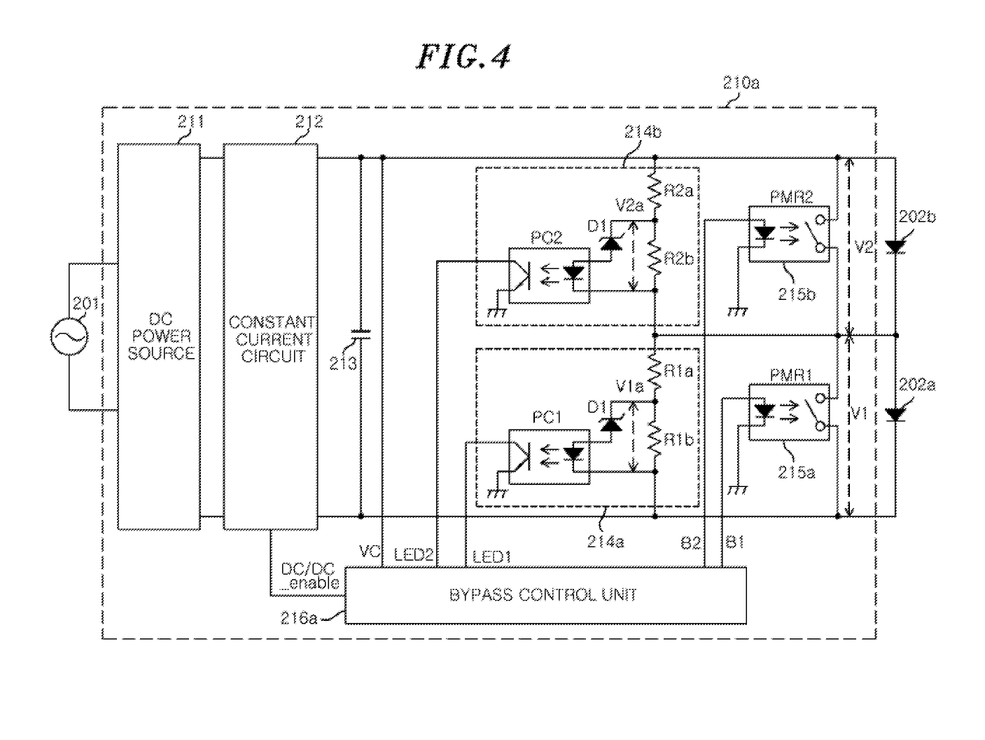

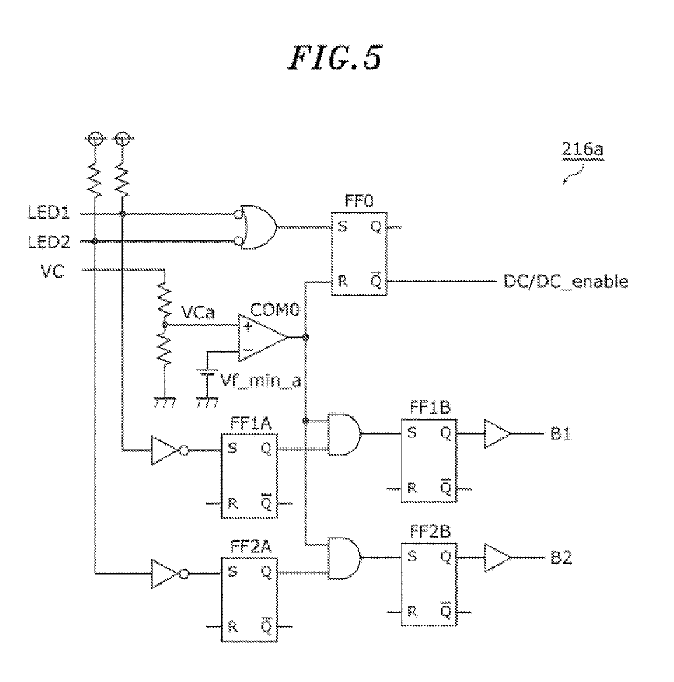

FIG. 4 is a diagram of example circuits of the detection circuits 214a and 214b and the bypass circuits 215a and 215b.

The detection circuit 214a detects whether a voltage difference V1 across the LED 202a rise above a predetermined voltage Vf_max, and outputs a failure detection signal LED1 indicating a result of the detection. The voltage Vf_max is equal to the maximum of the forward voltage of the LEDs 202a and 202b, for example.

The detection circuit 214a includes voltage-dividing resistors R1a and R1b, a zener diode D1, and a photo-coupler PC1. The voltage-dividing resistors R1a and R1b generate a voltage V1a by dividing the voltage V1. If the voltage V1a rises above a voltage Vf_max_a corresponding to the voltage Vf_max, the zener diode D1 is turned on. Accordingly, current flows in the photo-coupler PC1 so that the level of the failure detection signal LED1 is changed to be low.

Likewise, the detection circuit 214b detects whether a voltage difference V2 across the LED 202b rises above the predetermined voltage Vf_max, and outputs a failure detection signal LED2 indicating a result of the detection. The detection circuit 214b includes voltage-dividing resistors R2a and R2b, a zener diode D2, and a photo-coupler PC2. The voltage-dividing resistors R2a and R2b generate a voltage V2a by dividing the voltage V2. If the voltage V2a rises above the voltage Vf_max_a corresponding to the voltage Vf_max, the zener diode D2 is turned on. Accordingly, current flows in the photo-coupler PC2 so that the level of the failure detection signal LED2 is changed to be low.

The bypass circuit 215a includes a photo MOS relay PMR1. The photo MOS relay PMR1 is turned on if the level of a bypass control signal B1 is high. Likewise, the bypass circuit 215b includes a photo MOS relay PMR2. The photo MOS relay PMR2 is turned on if the level of a bypass control signal B2 is high.

FIG. 5 shows an example of a circuit diagram of the bypass control unit 216a. As shown in FIG. 5, the bypass control unit 216a includes flip-flops FF0, FF1A, FF1B, FF2A and FF2B, and a comparator COM0.

The comparator COM0 compares a voltage VCa, obtained by dividing the voltage VC, with a reference voltage Vf_min_a corresponding to a reference voltage Vf_min.

The flip-flop FF0 outputs a stop control signal DC/DC_enable of low level when the level of the failure detection signal LED1 or LED2 becomes low. In addition, the flip-flop FF0 outputs a stop control signal DC/DC_enable of high level in response to an output signal from the comparator COM0 when the voltage VCa becomes lower than the reference voltage Vf_min_a.

After the level of the failure detection signal LED1 has become low, the flip-flop FF1B outputs a bypass control signal B1 of high level in response to an output signal from the comparator COM0 when the voltage VCa becomes lower than the reference voltage Vf_min_a. After the level of the failure detection signal LED2 has become low, the flip-flop FF2B outputs a bypass control signal B2 of high level in response to an output signal from the comparator COM0 when the voltage VCa becomes lower than the reference voltage Vf_min_a.

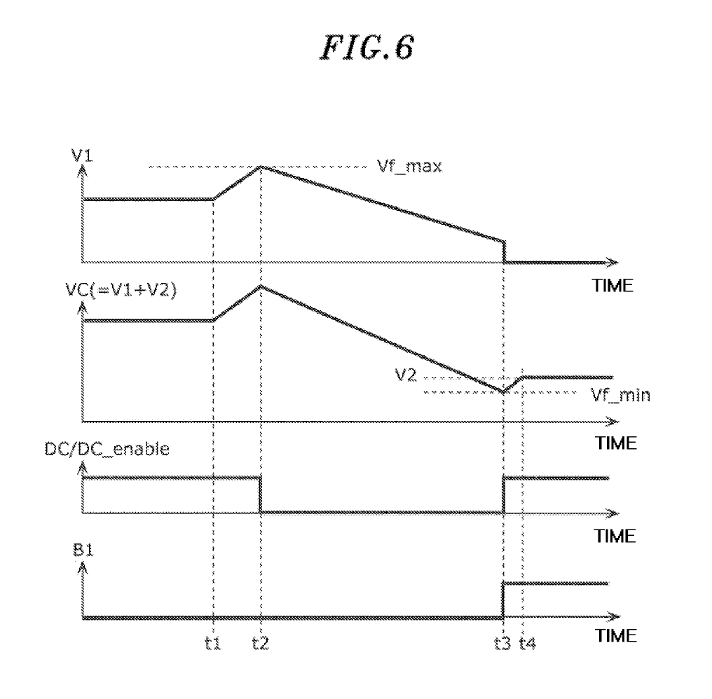

FIG. 6 is a timing chart when the LED 202a has an open-circuit failure. Hereinafter, operations when the LED 202a has an open-circuit failure will be described.

Before time t1 at which the open-circuit failure occurs, the voltage V1 across the LED 202a is equal to the forward voltage Vf of the LED 202a. In addition, the voltage VC (=V1+V2) is equal to the sum (2×Vf) of the forward voltages Vf of the LEDs 202a and 202b.

At time ti, the open-circuit failure occurs in the LED 202a. At this time, the constant-current circuit 212 keeps supplying current, and thus the voltage VC increases. In addition, the voltage V2 across the normal LED 202b does not increase any further once it has reached the forward voltage Vf, and thus the voltage V2 stays at the forward voltage Vf. Accordingly, the voltage V1 increases as the voltage VC increases. As the voltage V1 increases, so does the voltage V1a that is obtained by dividing the voltage V1.

At time t2, when the voltage V1a reaches the voltage Vf_max_a (when the voltage V1 reaches the voltage Vf_max), the zener diode D1 is turned on. Accordingly, current flows in the photo-coupler PC1 so that the photo-coupler PC1 is turned on. As a result, the level of the failure detection signal LED1 becomes low, so that the open-circuit failure in the LED 202a is detected.

When the open-circuit failure is detected, a high-level signal is inputted to the set terminal of the flip-flop FF0. Accordingly, the level of the stop control signal DC/DC_enable becomes low. As the stop control signal DC/DC_enable becomes low, the constant-current circuit 212 stops its operation.

As the constant-current circuit 212 stops its operation, electric charges accumulated in the smoothing capacitor 213 are released through, e.g., the resistors R2a, R2b, R1a and R1b. Accordingly, the voltage VC decreases.

At time t3, if the voltage VC becomes lower than the voltage Vf_min, the level of the stop control signal DC/DC_enable becomes high. Specifically, if the voltage VC decreases, so does the voltage VCa that is inputted to the comparator COM0. Then, if the voltage VCa becomes lower than the voltage Vf_min_a corresponding to the voltage Vf_min, the level of the output signal from the comparator COM0 becomes high. Accordingly, the level of the stop control signal DC/DC_enable becomes high.

As the level of the stop control signal DC/DC_enable becomes high, the constant-current circuit 212 starts its operation.

In addition, as the level of the bypass control signal B1 becomes high, the bypass circuit 215a is turned on. Specifically, a high-level signal is inputted to the set terminal of the flip-flop FF1B. Accordingly, the level of the bypass control signal B1 becomes high, and thus the photo MOS relay PMR1 is turned on.

If the constant-current circuit 212 starts its operation, the voltage VC increases. At time t4, the voltage VC reaches a voltage equal to the forward voltage Vf of the normal LED 202b, so that current flows in the normal LED 202b. In other words, the LED 202b is lit.

As described above, if an open-circuit failure occurs in the LED 202a, the bypass circuit 215a is turned on, and accordingly the current supplied from the constant-current circuit 212 flows in the normal LED 202b, passing through the bypass circuit 215a. In this manner, even if one of the LEDs has an open-circuit failure, the other normal LEDs can be supplied with current.

Further, according to the first embodiment, when the bypass circuit 215a is turned on, electric charges in the smoothing capacitor 213 are released. By doing so, it is possible to suppress excessive current from flowing in the bypass circuit 215a and the LED 202b. Therefore, it is possible to suppress deterioration or failure of the LED 202b and malfunction of the bypass circuit 215b.

Although the operations when the LED 202a has an open-circuit failure have been described in the foregoing description, the operations can be equally applied to the case where the LED 202b has an open-circuit failure.

Further, although the two LEDs connected in series have been used in the foregoing description, three or more LEDs connected in series may be used. In the latter instance, the above-described detection circuit and the bypass circuit are provided for each of the LEDs.

Furthermore, although each of the LEDs includes the detection circuit and the bypass circuit in the foregoing description, at least one of the LEDs may include the detection circuit and the bypass circuit.

As described above, in the lighting device 210a according to the first embodiment, the constant-current circuit 212 resumes its operation when the voltage VC becomes lower than the voltage Vf_min. As shown in FIG. 6, the voltage Vf_min is, e.g., lower than the sum of the forward voltages of the normal LEDs (the forward voltage Vf of the LED 202b in the example of FIG. 6). However, the voltage Vf_min may be higher than the sum of the forward voltages of the normal LEDs. By way of providing a predetermined discharge period, the voltage VC of when the bypass circuit is turned on can be more lowered, compared to the case where no discharge period is provided. Accordingly, currents flowing in the normal LEDs at the time when the bypass circuit is turned on can be reduced, so that deterioration or failure of the normal LEDs can be suppressed.

Moreover, by providing a longer discharge period (by setting the voltage Vf_min to be lower), this effect can be enhanced. Therefore, it is preferable that the voltage Vf_min is lower than the voltage VC in a normal operation state with no open-circuit failure, for example. Herein, the voltage VC in a normal operation state refers to the sum of the forward voltages of LEDs (2×Vf in the example of FIG. 6) in a state with no open-circuit failure. Further, as shown in FIG. 6, it is desirable that the voltage Vf_min is the sum of the forward voltages of the normal LEDs other than the LED having an open-circuit failure.

In the foregoing description, the constant-current circuit 212 stops during the discharge period until the bypass circuit is turned on. However, the output from the constant-current circuit may be lowered than usual, e.g., up to a level at which the smoothing capacitor 213 is discharged. Also in this manner, the voltage VC can be reduced during the discharge period.

As described above, the lighting device 210a according to the first embodiment includes: the constant-current circuit 212 that supplies a constant current to the plurality of LEDs 202a and 202b connected in series, the smoothing capacitor 213 connected between output terminals of the constant-current circuit 212; the bypass circuits 215a or 215b connected in parallel to one of the LEDs 202a and 202b so as to bypass the one LED 202a (or 202b); the detection unit (detection circuit 214a or 214b) configured to detect whether the one LED 202a (or 202b) is open-circuited; the bypass control unit 216a configured to, when the detection circuit 214a (or 214b) detects that the one LED 202a (or 202b) is open-circuited, discharge the smoothing capacitor 213 during the discharge period to then bypass the one LED 202a (or 202b) through the bypass circuit 215a (or 215b).

With this configuration, when an open-circuit failure occurs in the LED 202a, the lighting device 210a releases electric charges accumulated in the smoothing capacitor 213 and then turns on the bypass circuit 215a. By doing so, it is possible to suppress excessive current flowing in normal LEDs when the bypass circuit 215a is turned on.

Specifically, during the discharge period, the bypass control unit 216a may stop the constant-current circuit 212 or may reduce a value of the constant current supplied from the constant-current circuit 212.

By doing so, the lighting device 210a can discharge the smoothing capacitor 213 during the discharge period.

In addition, during the discharge period, the smoothing capacitor 213 may be discharged until the voltage at the smoothing capacitor 213 becomes smaller than the sum of the forward voltages of the LEDs 202a and 202b. In addition, during the discharge period, the smoothing capacitor 213 may be discharged until the voltage at the smoothing capacitor 213 becomes smaller than the forward voltage of the LED 202b other than the LED 202a among the LEDs 202a and 202b.

In this manner, the lighting device 210a can further discharge the smoothing capacitor 213, so that it is possible to further suppress current flowing in the normal LED 202b when the bypass circuit 215a is turned on.

Additionally, the bypass control unit 216a may include the comparator COM0 to compare the voltage VC at the smoothing capacitor 213 with the reference voltage Vf_min, and may terminate the discharge period when the voltage VC at the smoothing capacitor 213 becomes smaller than the reference voltage Vf_min and may bypass the LED 202a through the bypass circuit 215a.

By doing so, the lighting device 210a may turn on the bypass circuit 215a after the voltage VC has decreased up to a predetermined voltage.

### Second Embodiment

The second embodiment to be described below is a modification of the first embodiment. In addition to the elements of the first embodiment, the lighting device 210b according to the second embodiment further includes a discharge circuit for discharging electric charges in the smoothing capacitor 213 during the discharge period.

In the following description, descriptions will be made focusing on differences between the first and second embodiments, and redundant descriptions on the same elements will be omitted.

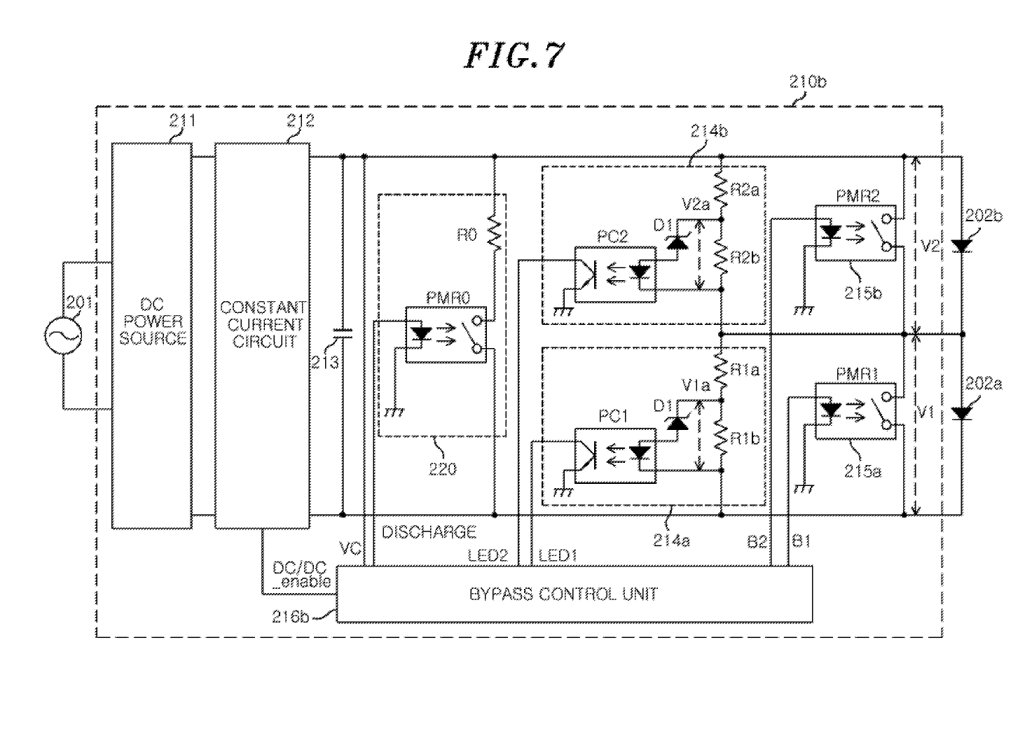

FIG. 7 is a circuit diagram of a lighting device 210b according to the second embodiment of the present invention. In addition to the elements shown in FIG. 3, the lighting device 210b shown in FIG. 7 further includes a discharge circuit 220. The bypass control unit 216b includes the functionality of the bypass control unit 216a.

The discharge circuit 220 is connected in parallel to the smoothing capacitor 213 and includes a switching element connected in parallel to the smoothing capacitor 213. For example, the discharge circuit 220 includes a photo MOS relay PMR0 and a resistor R0. As the photo MOS relay PMR0 is turned on, electric charges accumulated in the smoothing capacitor 213 are released through the resistor R0 and the photo MOS relay PMR0.

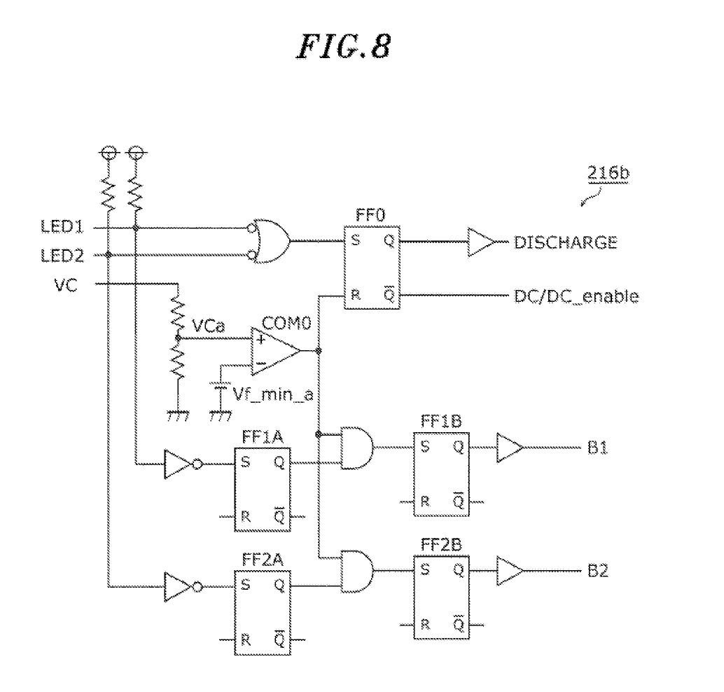

In addition to the functionality of the bypass control unit 216a, the bypass control unit 216b has the functionality of turning on the discharge circuit 220 during a discharge period. FIG. 8 shows an example of a circuit diagram of the bypass control unit 216b. As shown in FIG. 8, the bypass control unit 216b outputs a discharge control signal DISCHARGE that is an inverted signal of the stop control signal DC/DC_enable, in addition to the functionality of the bypass control unit 216a.

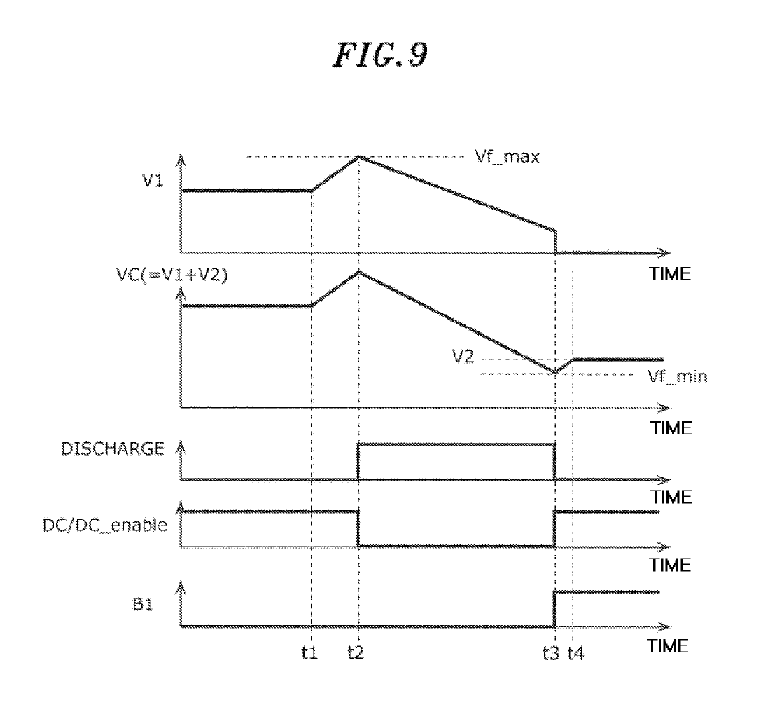

FIG. 9 is a timing chart when the LED 202a has an open-circuit failure in the lighting device 210b according to the second embodiment.

As shown in FIG. 9, at time t2, if the voltage V1 reaches the voltage Vf_max, the level of the discharge control signal DISCHARGE becomes high. In response to this, the photo MOS relay PMR0 is turned on, and accordingly electric charges accumulated in the smoothing capacitor 213 are released through the resistor R0 and the photo MOS relay PMR0.

By employing the discharge circuit 220 in this manner, the discharge period (from time t2 to time t3) can be more shortened than that of the first embodiment.

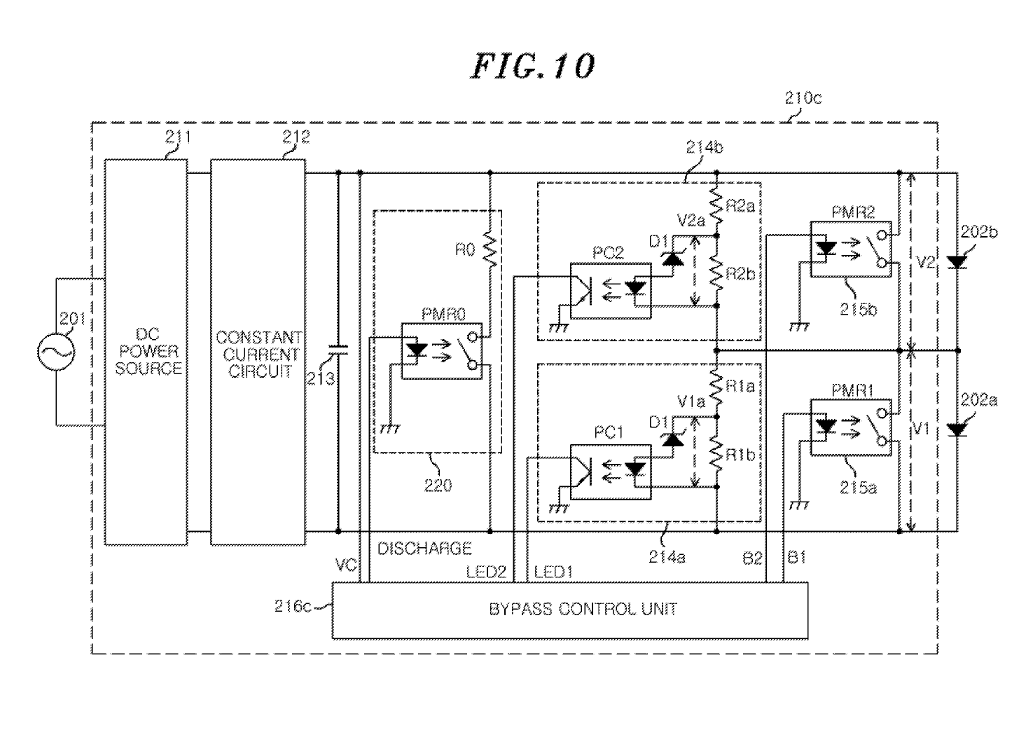

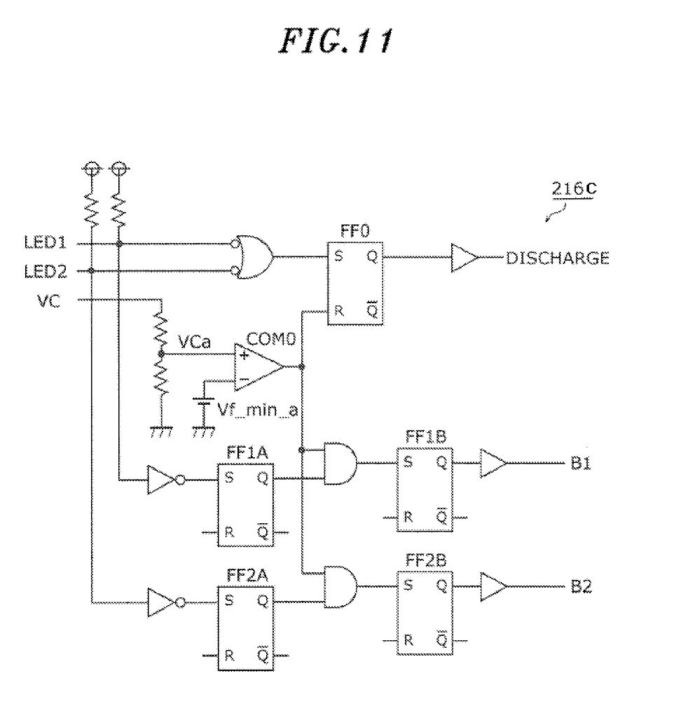

Herein, the constant-current circuit 212 stops and the discharge circuit 220 is turned on during the discharge period. However, the constant-current circuit 212 may not stop. FIG. 10 shows a circuit diagram of a lighting device 210c according to this instance. The configuration shown in FIG. 10 is identical to that of FIG. 7 except that the bypass control unit 216c does not output the stop control signal DC/DC_enable. FIG. 11 shows an example of a circuit diagram of the bypass control unit 216c.

As such, even if the constant-current circuit 212 does not stop, the smoothing capacitor 213 is discharged through the discharge circuit 220, and therefore the same effect as the above can be achieved.

As described above, the lighting devices 210b and 210c may further include the discharge circuit 220 connected in parallel to the smoothing capacitor 213, and the bypass control unit 216b or 216c may turn on the discharge circuit 220 during the discharge period to discharge the smoothing capacitor 213.

By doing so, the smoothing capacitor 213 can be discharged during the discharge period.

### Third Embodiment

In the above embodiments, the discharge period terminates when the voltage VC becomes lower than the predetermined voltage Vf_min. According to the third embodiment, the discharge period terminates after a predetermined time period has elapsed from the start of the discharge period.

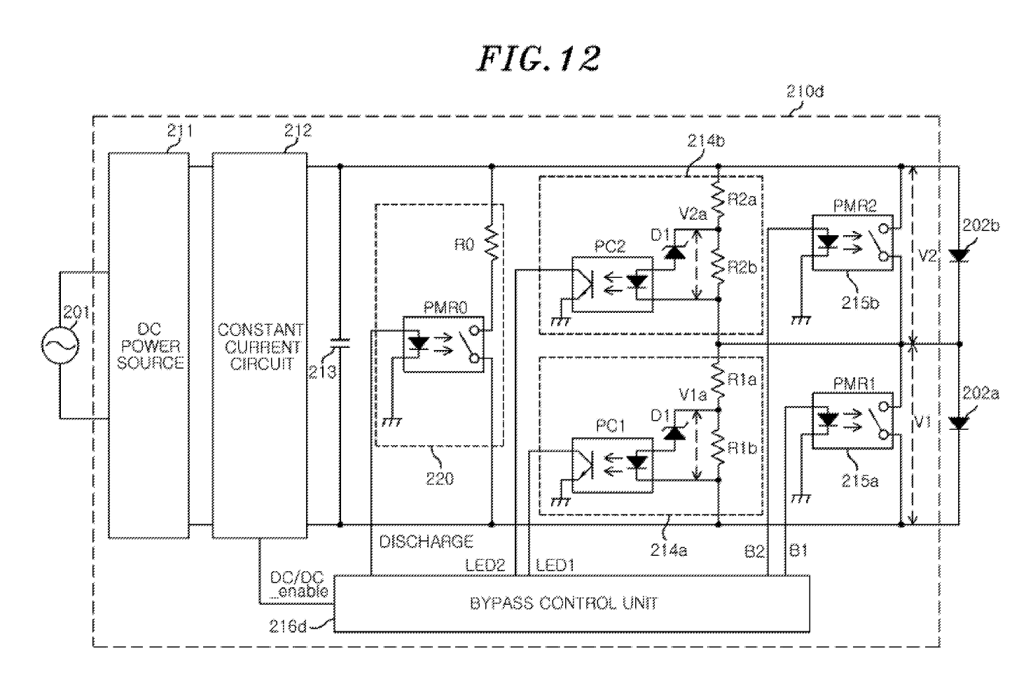

FIG. 12 is a circuit diagram of a lighting device 210d according to the third embodiment of the present invention. The configuration of the lighting device 210d shown in FIG. 12 is identical to that of FIG. 7 except that the configuration of a bypass control unit 216d is different from that of the bypass control unit 216b. As in the configuration shown in FIG. 7, the configuration in which the discharge circuit 220 is employed and the constant-current circuit 212 stops during the discharge period will be described as an example in this embodiment. However, the discharge circuit 220 may not be employed or the constant-current circuit 212 may not stop during the discharge period.

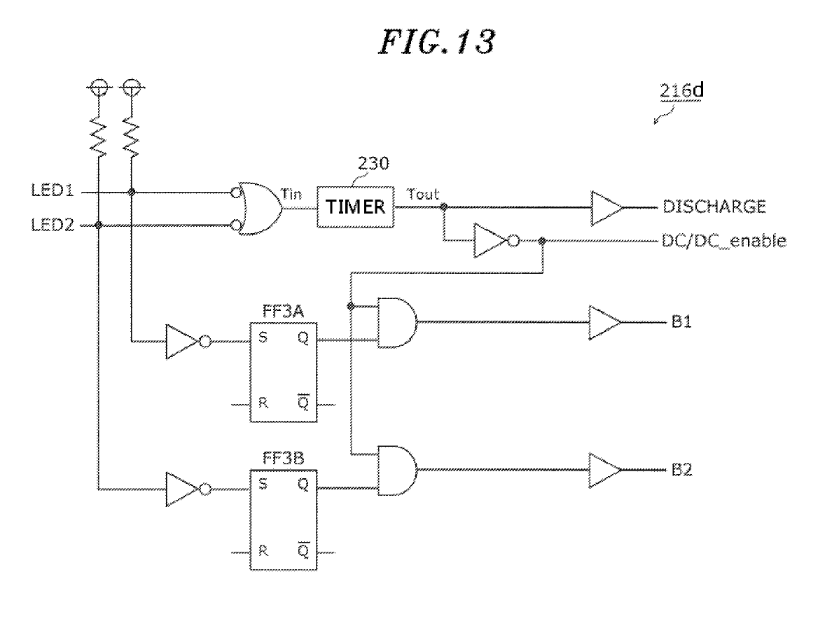

The bypass control unit 216d terminates the discharge period after a predetermined time period has elapsed from the start of the discharge period. FIG. 13 shows an example of a circuit diagram of the bypass control unit 216d. As shown in FIG. 13, the bypass control unit 216d includes a timer 230, and flip-flops FF3A and FF3B.

The timer 230 outputs a discharge control signal DISCHARGE of high level and a stop control signal DC/DC_enable of low level for a predetermined time period after the level of a failure detection signal LED1 or LED2 has become low. Further, the timer 230 outputs the discharge control signal DISCHARGE of low level and the stop control signal DC/DC_enable of high level after the predetermined time period has elapsed.

After the level of the failure detection signal LED1 becomes low, the flip-flop FF3A outputs a bypass control signal B1 of high level if the level of the stop control signal DC/DC_enable is high. After the level of the failure detection signal LED2 becomes low, the flip-flop FF3B outputs a bypass control signal B2 of high level if the level of the stop control signal DC/DC_enable is high.

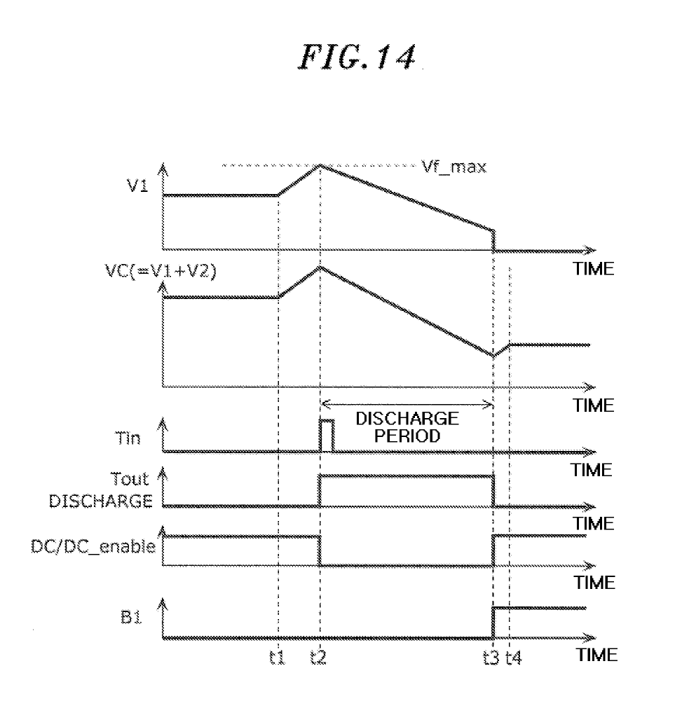

FIG. 14 is a timing chart when the LED 202a has an open-circuit failure in the lighting device 210d according to the third embodiment. As shown in FIG. 14, at time t2, when the voltage V1 reaches the voltage Vf_max, the level of an input signal Tin of the timer 230 becomes high. Then, the timer 230 outputs an output signal Tout of high level for a predetermined time period. Accordingly, for the predetermined time period, the level of the discharge control signal DISCHARGE is high and the level of the stop control signal DC/DC_enable is low. As a result, during the discharge period, the constant-current circuit 212 stops and the discharge circuit 220 is tuned on.

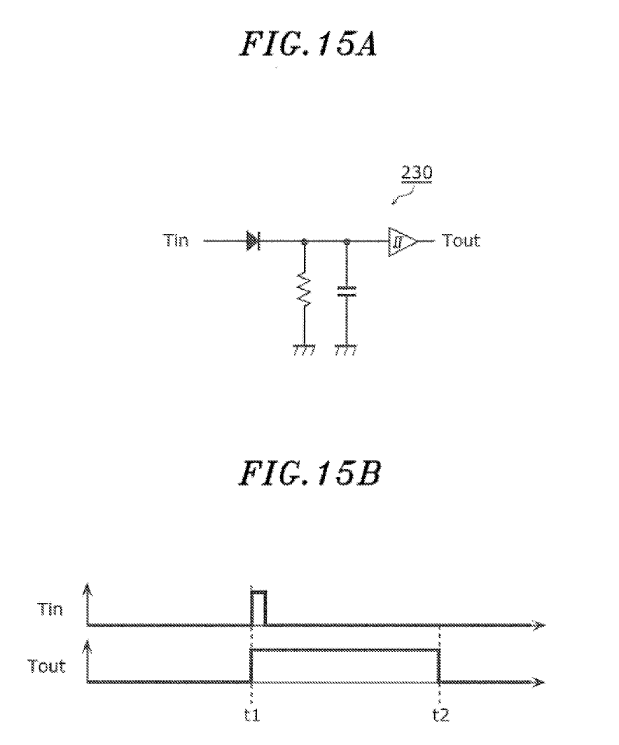

FIG. 15A shows an example of a circuit diagram of the timer 230. FIG. 15B is a timing chart showing relationship between the input signal Tin and the output signal Tout of the timer 230. As can be seen from FIGS. 15A and 15B, when the level of the input signal Tin becomes high, the level of the output signal Tout also becomes high and then becomes low after a predetermined time period elapses.

Herein, the discharge period from when the level of the output signal Tout becomes high until it becomes low corresponds to the above-described discharge period. Therefore, it is desirable that the discharge period is set to be long enough so that the voltage VC becomes lower than the voltage Vf_min (e.g., the sum of the forward voltages of normal LEDs) when the discharge period terminates. For example, the discharge period is set to be longer than a time constant of a discharge path (the discharge circuit 220, in this example) through which electric charges in the smoothing capacitor 213 are released during the discharge period. Further, as described above, the voltage VC may not be lowered than the sum of the forward voltages of normal LEDs when the discharge period terminates. Even though the voltage VC is not lowered enough, the voltage VC can be decreased when the bypass circuit is turned on. Therefore, it is possible to suppress excessive current from flowing in normal LEDs, compared to the case where no discharge period is provided.

As described above, after the detection circuit 214a detects that the LED 202a is open-circuited, the bypass control unit 216d may terminate the discharge period after a predetermined time period has elapsed and may bypass the LED 202a through the bypass circuit 215a.

Accordingly, the discharge period can be set as required.

Further, the discharge period may be longer than the time constant of the discharge path through which the smoothing capacitor 213 is discharged.

By doing so, electric charges in the smoothing capacitor 213 can be released sufficiently until the bypass circuit 215a is turned on.

### Fourth Embodiment

According to the fourth embodiment, the same functionalities of the above embodiments are implemented by using an MCU (microcontroller).

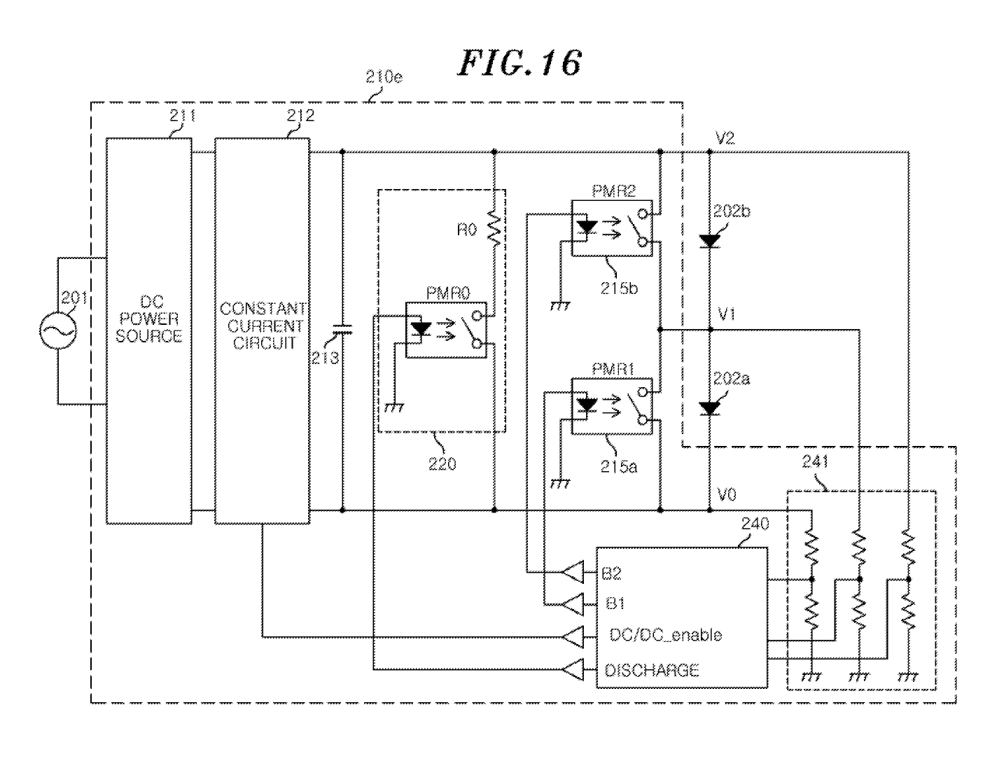

FIG. 16 is a circuit diagram of a lighting device 210e according to the fourth embodiment of the present invention. The configuration of the lighting device 210e shown in FIG. 16 is identical to that of FIG. 7 except that the lighting device 210e includes an MCU 240 and a group of voltage-dividing resistors 241, in place of the bypass control unit 216b and the detection circuits 214a and 214b. As in the configuration shown in FIG. 7, the discharge circuit 220 is employed and the constant-current circuit 212 stops during the discharge period in this embodiment. However, the discharge circuit 220 may not be employed or the constant-current circuit 212 may not stop during the discharge period.

By the MCU 240 and the group of voltage-dividing resistors 241, the same functionality as the above-described bypass control unit 216b and the detection circuits 214a and 214b is achieved.

As shown in FIG. 16, the group of voltage-dividing resistors 241 generates voltages V0a, V1a and V2a by dividing the voltages V0, V1 and V2, respectively.

The MCU 240 is a microcontroller and detects whether any of the LEDs 202a and 202b has an open-circuit failure by using the voltages V0a, V1a and V2a, in addition to the functionality of the bypass control unit 216b.

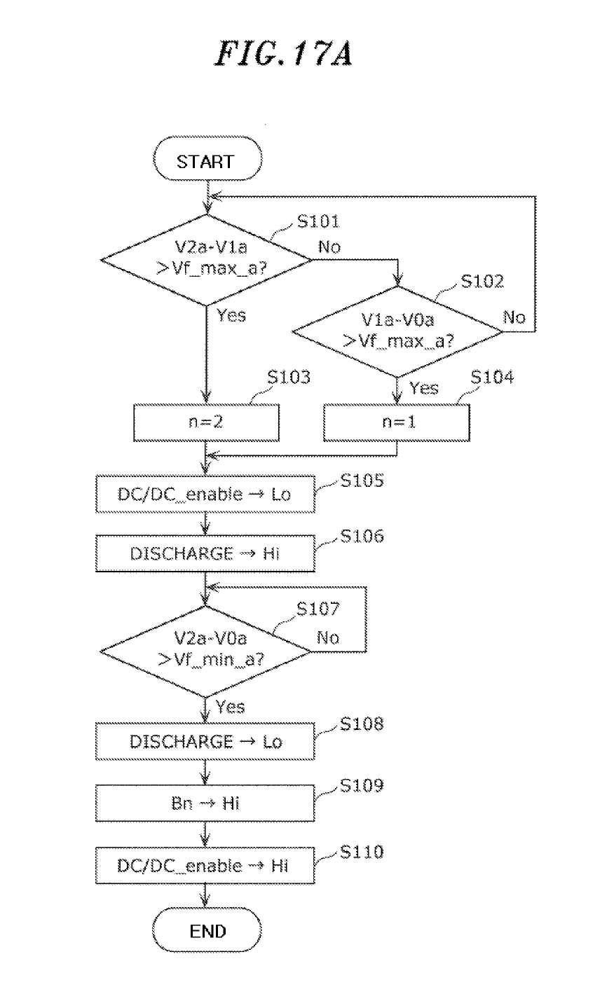

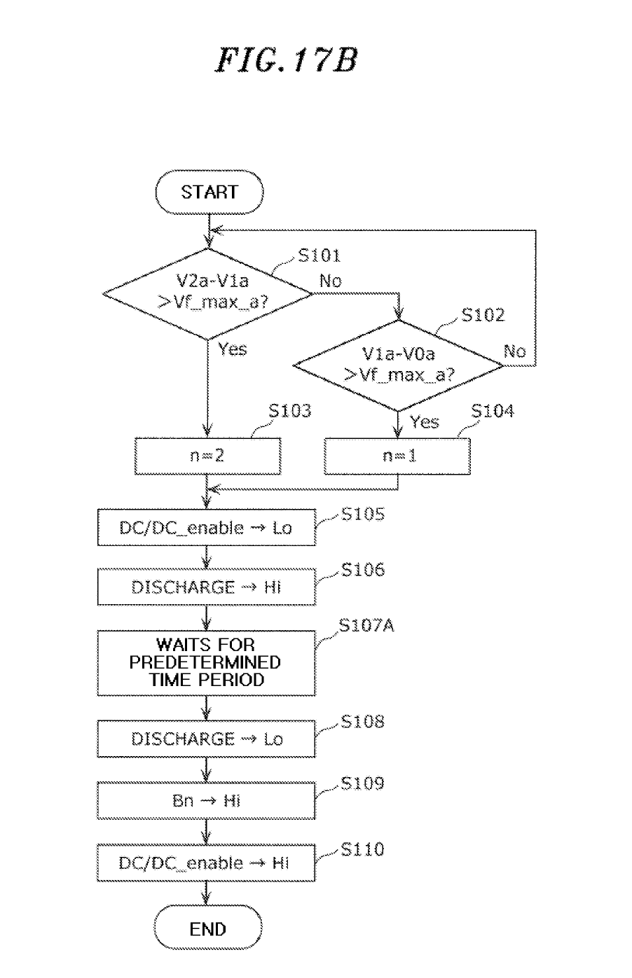

Hereinafter, the operation of the microcontroller will be described in detail. FIG. 17A is a flowchart for illustrating the operation of the MCU 240.

The MCU 240 includes an A/D converter that converts the voltages V0a, V1a and V2a into digital signals. The MCU 240 calculates differences in voltages, i.e., V2a−V1a and V1a−V0a, and determines whether each of the differences is greater than Vf_max_a (in step S101 and S102). By doing so, the MCU 240 determines whether each of the LEDs 202a and 202b has an open-circuit failure. The voltage Vf_max_a is a value corresponding to the voltage Vf_max (e.g., the maximum of the forward voltages of LEDs).

If the difference V2a−V1a is greater than the voltage Vf_max_a (Yes in step S101), the MCU 240 determines that the LED 202b has an open-circuit failure and sets a variable “n” to be “2” (in step S103). Further, if the difference V1a−V0a is greater than the voltage Vf_max_a (Yes in step S102), the MCU 240 determines that the LED 202a has an open-circuit failure and sets the variable “n” to be “1” (in step S104).

Subsequent to step S103 or S104, the MCU 240 sets the level of the stop control signal DC/DC_enable to be low (in step S105), and sets the level of the discharge control signal DISCHARGE to be high (in step S106). As a result, the constant-current circuit 212 stops and the discharge circuit 220 is tuned on.

Then, the voltage V2−V0 across the smoothing capacitor 213 decreases. The MCU 240 calculates the voltage V2a−V0a, and determines whether a result of the calculation is less than Vf_min_a (in step S107). The voltage Vf_min_a is a value corresponding to the voltage Vf_min (e.g., a value smaller than the sum of the forward voltages of normal LEDs).

If the voltage V2a−V0a is less than the voltage Vf_min_a (Yes in step S107), the MCU 240 sets the level of the discharge control signal DISCHARGE to be high to thereby turn off the discharge circuit 220.

Subsequently, the MCU 240 sets the level of a bypass control signal Bn (where n is a value (1 or 2) set in step S103 or S104) to be high to thereby turn on the bypass circuit 215a or 215b (in step S109). Namely, if the LED 202a has an open-circuit failure (n=1), the MCU 240 sets the level of the bypass control signal B1 to be high to thereby turn on the bypass circuit 215a. If the LED 202b has an open-circuit failure (n=2), the MCU 240 sets the level of the bypass control signal B2 to be high to thereby turn on the bypass circuit 215b.

Thereafter, the MCU 240 sets the level of the stop control signal DC/DC enable to be high to thereby operate the constant-current circuit 212 (in step S110).

In the above-described manner, the same operations as those of the second embodiment are implemented.

As in the third embodiment, the MCU 240 may end the discharge period after a predetermined time period has elapsed from the start of the discharge period. FIG. 17B is a flowchart for illustrating the operation of the MCU 240 in this instance. The processes illustrated in FIG. 17B are identical to those of FIG. 17A except that step S107 is replaced with step S107A.

Subsequent to step S106, the MCU 240 waits for a predetermined time period (discharge period) (in step S107A). Thereafter, the MCU 240 performs the processes of step S108 and subsequent steps.

Thus far, the lighting devices according to the embodiments have been described. However, the present invention is not limited to the above embodiments.

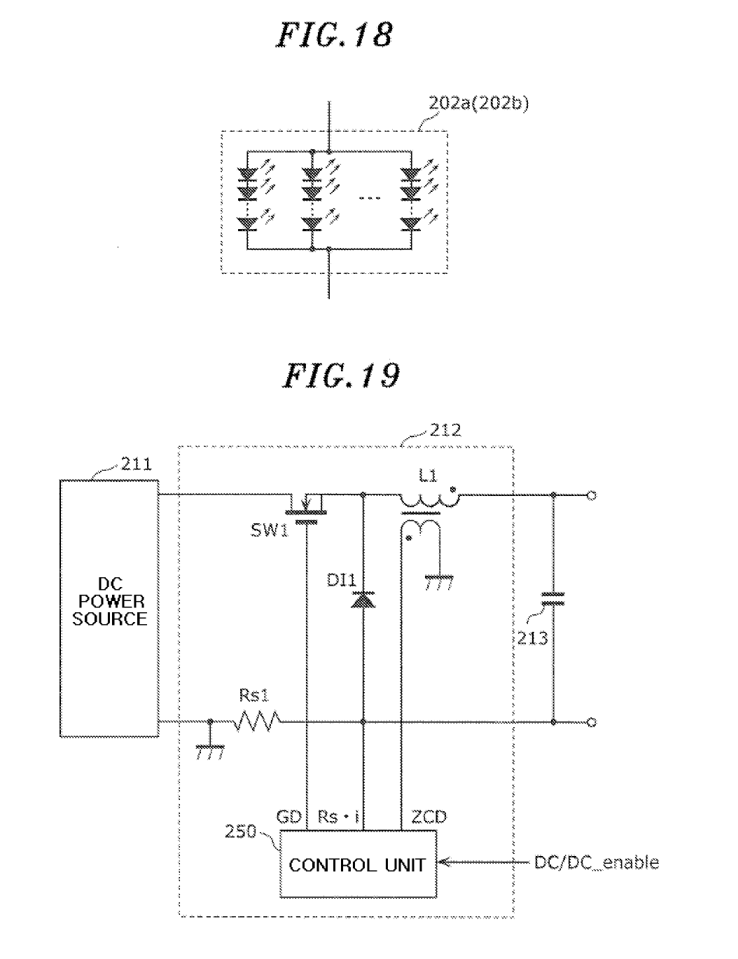

For example, although one bypass circuit has been provided for one light-emitting element in the above embodiments, one bypass circuit may be provided for a plurality of light emitting elements. The light-emitting elements may be connected to one another either in parallel or in series. Further, as shown in FIG. 18, groups of light-emitting elements, each group having light-emitting elements connected in series, may be connected to one another in parallel. In other words, the light-emitting element may be a single LED or may include LEDs connected in series and/or in parallel. Further, the light-emitting element may be an LED module including a plurality of LED chips or may include a plurality of LED modules.

Although an LED has been used as the solid-state light-emitting element in the above embodiments, an organic EL (Electro-Luminescence) element may be used as the solid-state light-emitting element.

Further, in the above description, a photo MOS relay has been used as the switching element employed in the bypass circuit and the discharge circuit. However, an MOSFET (Metal Oxide Semiconductor Field Effect Transistor), a thyristor, a triac, a photo-coupler, a power transistor, an IGBT (Insulated Gate Bipolar Transistor), a relay, a bimetal or the like may be used as the switching element.

Further, different control may be conducted in a normal operation state (where no open-circuit failure occurs in light-emitting elements) and a bypass state in which the bypass circuit is turned on (after an open-circuit failure has occurred in a light-emitting element).

For example, when an open-circuit failure has occurred, a light-emitting element having the open-circuit failure is not lit, and thus a less number of light-emitting elements are lit in a bypass state. Therefore, the brightness degrades in the case where constant current is supplied. To cope with this, the constant-current circuit 212 may supply to the light-emitting element a larger current in the bypass state than in the normal operation state. By doing so, difference in optical power between the bypass state and the normal operation state can be reduced.

Further, the constant-current circuit 212 may intermittently supply current to the light-emitting elements in the bypass state. In this case, the light-emitting elements blink on and off in the bypass state, so that a user can notice that a light-emitting element has been open-circuited due to a failure or a bad connection of the light-emitting element.

The constant-current circuit (212) is, e.g., a DC-to-DC converter. Hereinafter, a specific example of the constant-current circuit 212 will be described.

FIG. 19 is a circuit diagram showing a specific example of the constant-current circuit 212. The constant-current circuit 212 shown in FIG. 19 is of a step-down DC-to-DC converter, and includes a switching element SW1, an inductor L1, a diode DI1, a resistor Rs1, and a control unit 250. The smoothing capacitor 213 is disposed outside the constant-current circuit 212, but may be included in the constant-current circuit 212.

The switching element SW1 is connected in series to the DC power source 211 and is turned on and off by the control unit 250.

The inductor L1 is connected in series to the switching element SW1. When the switching element SW1 is turned on, current from the DC power source 211 flows in the inductor L1.

The diode DI1 is an element through which current discharged from the inductor L1 is supplied to the LEDs 202a and 202b.

The resistor Rs1 is to generate a voltage Rs·i that corresponds to a current flowing in the switching element SW1 (LEDs 202a and 202b).

The control unit 250 generates a signal GD to control on/off of the switching element SW1 based on a signal ZCD from a secondary winding of the inductor L1 and the voltage Rs·i. The signal ZCD is proportional to a time differential of a current flowing in the inductor L1 and is used to detect whether the current flowing in the inductor becomes zero.

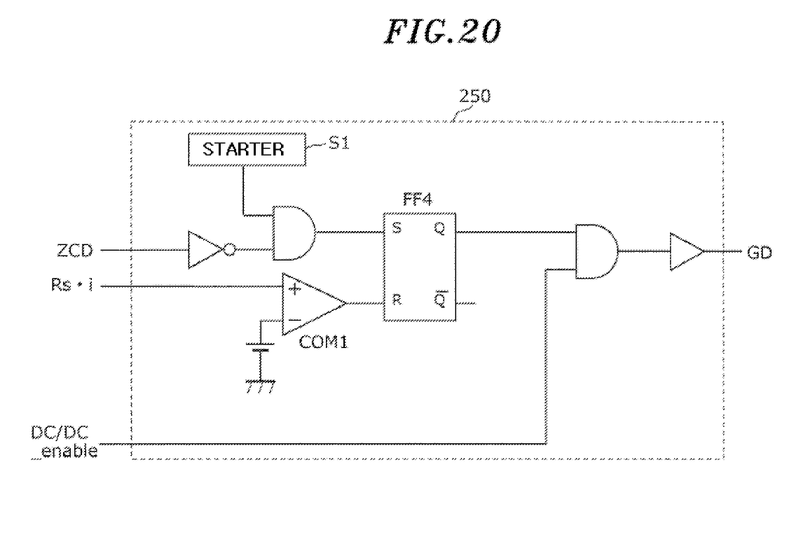

FIG. 20 is a circuit diagram of an example of the control unit 250. In order to start the constant-current circuit 212, a starter S1 generates a start pulse signal so that the level of the Q output (signal GD) of a flip-flop FF4 becomes high. As a result, the switching element SW1 is turned on.

As the switching element SW1 is turned on, current from the DC power source 211 flows in the switching element SW1, the inductor L1, the LED 202a and the LED 202b. This current increases over time. When this current reaches a peak current, the level of an output signal from a comparator COM1 becomes high, so that the level of the Q output (signal GD) of the flip-flop FF4 becomes low. As a result, the switching element SW1 is turned off.

When the switching element SW1 is turned off, the diode DI1 becomes conductive, so that current flows in the inductor L1 and the diode DI1. This current decreases from the peak current over time. When the current flowing in the inductor L1 becomes zero, the level of the signal ZCD becomes low. In response to this, the level of the Q output (signal GD) of the flop-flop FF4 becomes high, and accordingly the switching element SW1 is turned on again.

By repeating the above operations, the constant-current circuit 212 supplies constant current to the LEDs 202a and 202b.

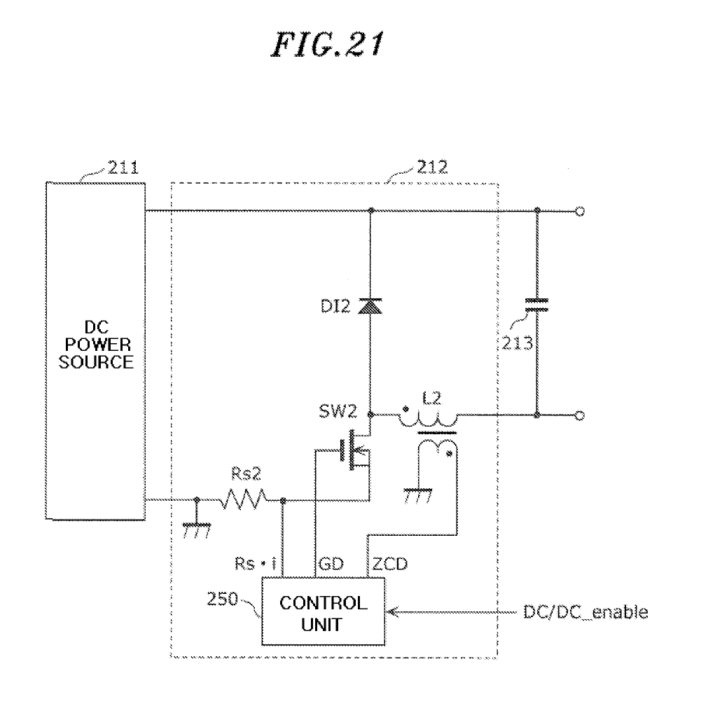

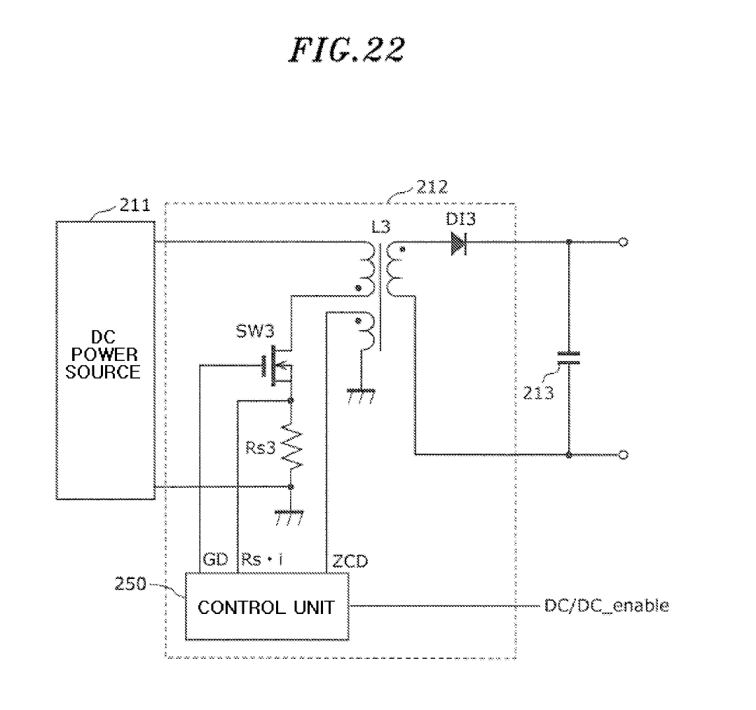

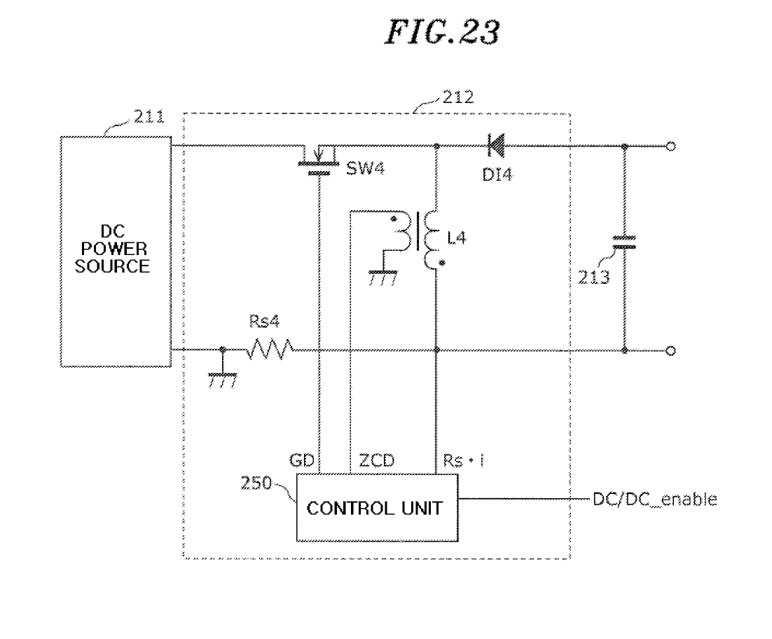

A step-down DC-to-DC converter shown in FIG. 21, a flyback DC-to-DC converter shown in FIG. 22, or a step-up/step-down DC-to-DC converter shown in FIG. 23 may be used as the constant-current circuit 212.

As described above, the constant-current circuit 212 is a DC-to-DC converter, and may include the switching element SW1 (or SW2 or SW3 or SW4), the inductor L1 (or L2 or L3 or L4) in which current from the DC power source 211 flows while the switching element SW1 (or SW2 or SW3 or SW4) is turned on, the diode DI1 (or DI2 or DI3 or DI4) through which current discharged from the inductor L1 (or L2 or L3 or L4) is supplied to the LEDs 202a and 202b, and the control unit 250 that controls on/off of the switching element SW1 (or SW2 or SW3 or SW4).

### Fifth Embodiment

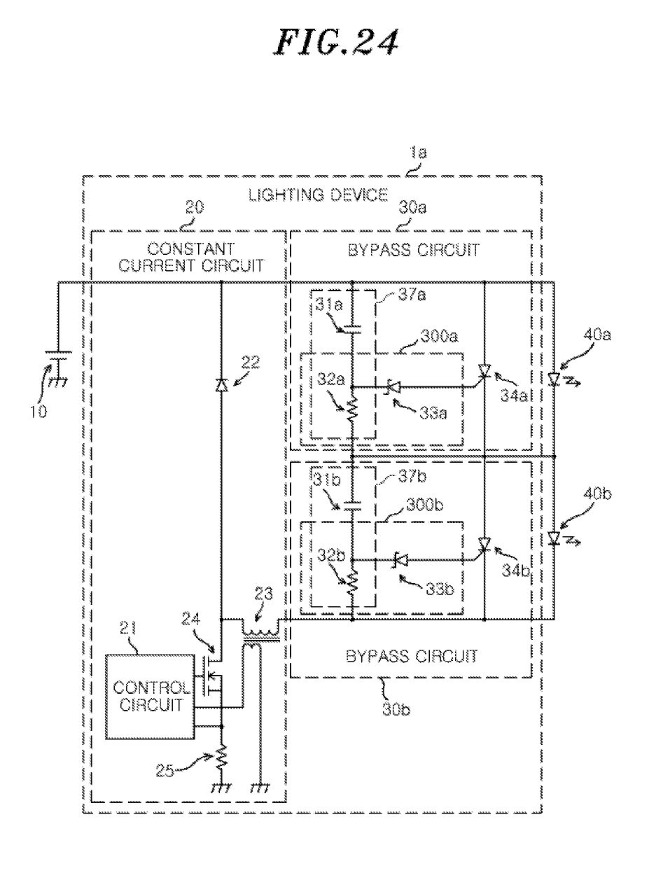

At first, elements of a lighting device according to the fifth embodiment will be described with reference to FIG. 24.

FIG. 24 is a circuit diagram of a lighting device according to the fifth embodiment of the present invention.

As shown in FIG. 24, the lighting device 1a according to the fifth embodiment receives DC power from a DC power source 10 to light LEDs 40a and 40b connected in series. The lighting device 1a includes a constant-current circuit 20 and bypass circuits 30a and 30b.

The LEDs 40a and 40b shown in FIG. 24 are solid-state light-emitting elements that are connected in series and are lit upon receiving current from the constant-current circuit 20. Each of the LEDs 40a and 40b may be formed of a single LED chip or may be formed of LED chips connected in series or in parallel.

The constant-current circuit 20 shown in FIG. 24 converts current supplied from the DC power source 10 to a predetermined current and supplies the predetermined current to the LEDs 40a and 40b connected in series. The constant-current circuit 20 includes a control circuit 21, a diode 22, an inductor 23, a FET (field effect transistor) 24, and a detection resistor 25.

The control circuit 21 of the constant-current circuit 20 outputs a signal to control on/off of the FET 24.

The FET 24 of the constant-current circuit 20 is a switching element that is controlled by the signal outputted from the control circuit 21.

The inductor 23 of the constant-current circuit 20 is an inductive element through which current from the DC power source 10 flows while the FET 24 is tuned on.

The diode 22 of the constant-current circuit 20 is an element through which current discharged from the inductor 23 is supplied to the LEDs 40a and 40b.

The detection resistor 25 of the constant-current circuit 20 is for detecting current flowing in the FET 24.

In this embodiment, the constant-current circuit 20 is a DC-to-DC converter that performs BCM (boundary current mode) control. Specifically, while the FET 24 is conductive, the control circuit 21 of the constant-current circuit 20 detects whether a current flowing in the detection resistor 25 reaches a peak current and, if so, turns the FET 24 to be non-conductive. Additionally, while the FET 24 is non-conductive, the control circuit 21 detects whether the current flowing in the inductor 23 becomes zero and, if so, turns the FET 24 to be conductive.

The bypass circuits 30a and 30b shown in FIG. 24 are connected in parallel to the LED 40a and 40b, respectively. The bypass circuits 30a and 30b provide bypass paths for bypassing the LEDs 40a and 40b, respectively, when open-circuit failures occur in the LED 40a and 40b. The bypass circuit 30a includes a capacitor 31a, a resistor 32a, a zener diode 33a and a thyristor 34a. The bypass circuit 30b includes a capacitor 31b, a resistor 32b, a zener diode 33b and a thyristor 34b.

The capacitor 31a and the resistor 32a are connected in series to each other and form a capacitor circuit 37a. The capacitor circuit 37a is connected in parallel to the LED 40a. Likewise, the capacitor 31b and the resistor 32b are connected in series to each other and form a capacitor circuit 37b. The capacitor circuit 37b is connected in parallel to the LED 40b. Herein, the resistors 32a and 32b are also included in current detection units 300a and 300b, respectively.

If open-circuit failures occur in the LEDs 40a and 40b, currents flowing in the capacitors 31a and 31b increase, respectively. Therefore, the open-circuit failures can be detected by measuring the currents. The capacitors 31a and 31b also work as smoothing capacitors for the output from the constant-current circuit 20. Namely, pulsating components in the output current from the constant-current circuit 20 caused by the switching of the FET 24 are smoothened by the capacitors 31a and 31b, so that smooth DC current flows in the LEDs 40a and 40b.

The thyristor 34a of the bypass circuit 30a and the thyristor 34b of the bypass circuit 30b are bypass switches that are connected in parallel to the capacitor circuits 37a and 37b, respectively.

The resistor 32a and the zener diode 33a of the bypass circuit 30a constitute a current detection unit 300a that detects whether a current flowing in the capacitor 31a exceeds a predetermined threshold Ith. Specifically, a current flowing in the capacitor 31a is measured by the zener diode 33a based on a voltage across the resistor 32a connected in series to the capacitor 31a. When the current I31a flowing in the capacitor 31a exceeds the threshold Ith, a zener voltage Vza is determined so that the voltage across the resistor 32a exceeds the zener voltage Vza of the zener diode 33a. Accordingly, the zener voltage Vza is determined by the following equation:

Vza=Ra×Ith (Equation 1)

where Ra denotes the resistance of the resistor 32a.

In addition, when the measured current exceeds the threshold Ith, the current detection unit 300a allows current to flow from the zener diode 33a to the thyristor 34a to thereby turn the thyristor 34a to be conductive.

Likewise, the resistor 32b and the zener diode 33b of the bypass circuit 30b constitute a current detection unit 300b that detects whether a current flowing in the capacitor 31b exceeds a predetermined threshold Ith. The zener voltage Vzb of the zener diode 33b is determined by the following equation:

Vzb=Rb×Ith (Equation 2)

where Rb denotes the resistance of the resistor 32b.

When the measured current exceeds the threshold Ith, the current detection unit 300b allows current to flow from the zener diode 33b to the thyristor 34b to thereby turn the thyristor 34b to be conductive.

The threshold Ith is larger than the output current from the constant-current circuit 20 and equal to or less than two times the output current. Herein, the output current from the constant-current circuit 20 corresponds to a peak current flowing in the capacitors 31a and 31b in the normal operation state (where no open-circuit failure has occured in the LEDs 40a and 40b). The two times the output current from the constant-current circuit 20 corresponds to a peak current flowing in the capacitors 31a or 31b when an open-circuit failure has occurred in the LED 40a or 40b.

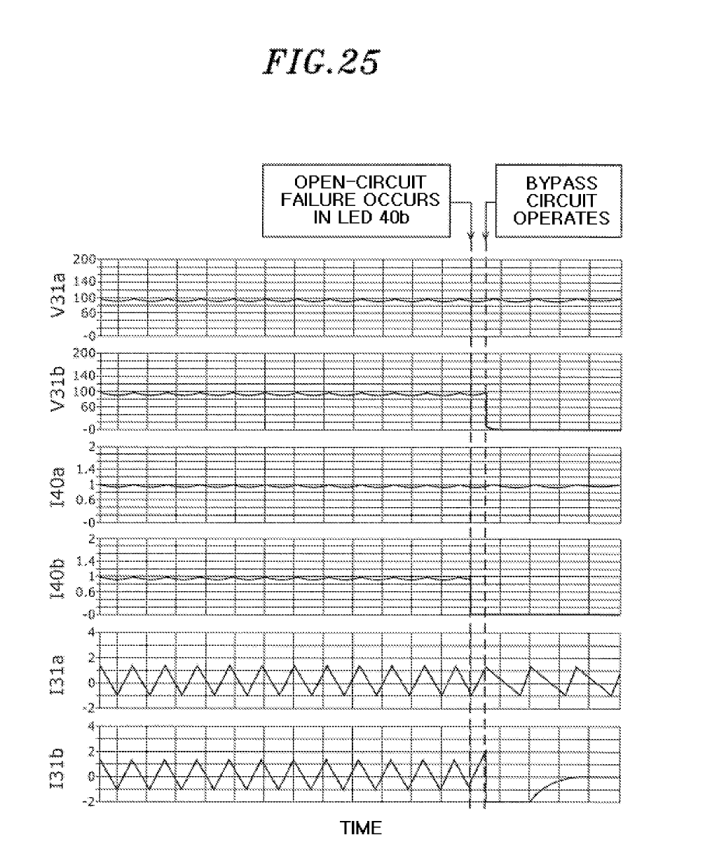

Next, the operations of the lighting device 1a and the bypass circuits 30a and 30b according to the fifth embodiment will be described. As an example of the operations, a scenario where an open-circuit failure occurs in the LED 40b will be described with reference to FIGS. 25 to 27.

FIG. 25 shows graphs of waveforms of voltages V31a and V31b across the capacitors 31a and 31b of the lighting device 1a, respectively, versus time. FIG. 25 also shows graphs of waveforms of currents I31a, I31b, I40a and I40b flowing in the capacitor 31a and 31b and the LEDs 40a and 40b, respectively, versus time.

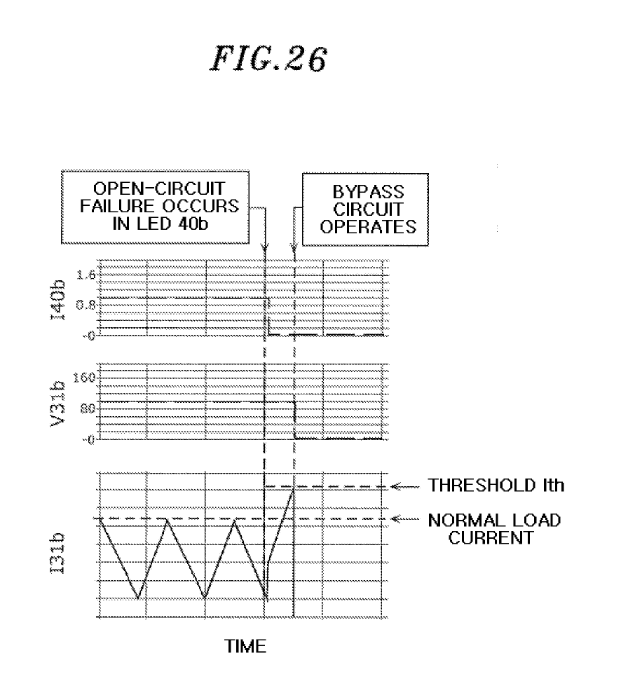

FIG. 26 is an enlarged view of a part of the waveforms of voltages and currents shown in FIG. 25. FIG. 26 shows the waveforms of the currents I40b and I31b flowing in the LED 40b and the capacitor 31b, respectively, versus time, and the waveform of the voltage V31b across the capacitor 31b versus time.

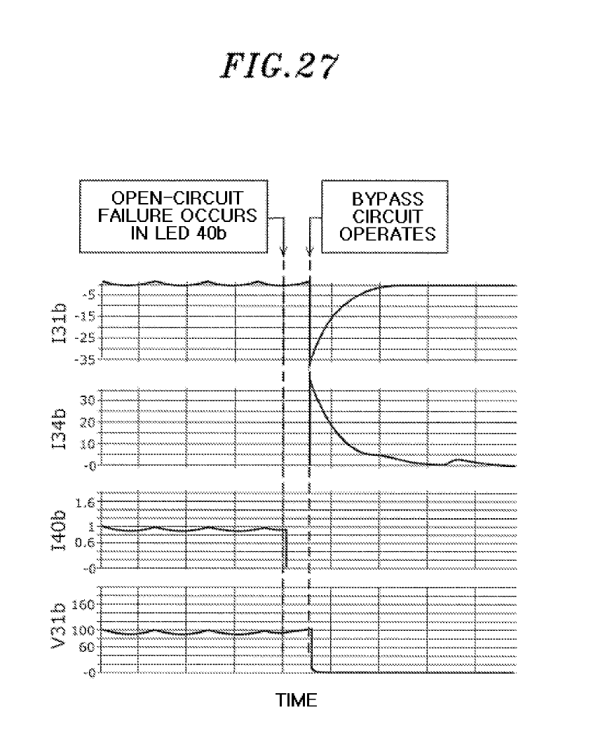

FIG. 27 is an enlarged view of a part of the waveforms of voltages and currents shown in FIG. 25, and there is also depicted a waveform of the current I34b flowing in the thyristor 34b versus time. FIG. 27 shows the waveforms of the currents I31b, I34b and I40b flowing in the capacitor 31b, the thyristor 34b and the LED 40b, respectively, versus time. FIG. 27 further shows the waveform of the voltage V31b across the capacitor 31b versus time.

For the lighting device 1a according to the fifth embodiment, if an open-circuit failure occurs in the LED 40b, the current I40b flowing in the LED 40b becomes zero, as shown in FIGS. 25 to 27. When no more current flows in the LED 40b, the current having flowed in the LED 40b before the open-circuit failure occurs flows to the capacitor 31b connected in parallel to the LED 40b. Therefore, as shown in FIGS. 25 and 26, a DC component is added to the current I31b flowing in the capacitor 31b. Herein, the DC component refers to a frequency component lower than the switching frequency of the FET 24. Then, as described above, the current I31b flowing in the capacitor 31b increases up to about two times the peak current of a normal operation state. Further, the voltage V31b across the capacitor 31b increases slowly.

As the current I31b flowing in the capacitor 31b increases, the current flowing through the resistor 32b connected in series to the capacitor 31b and the voltage across the resistor 32b also increase. Further, when the current I31b flowing in the capacitor 31b exceeds the threshold Ith and the voltage across the resistor 32b exceeds the zener voltage Vzb of the zener diode 33b, current abruptly flows in the zener diode 33b. The current flows from the anode of the zener diode 33b to the gate of the thyristor 34b, so that the thyristor 34b becomes conductive. Consequently, a bypass path for bypassing the LED 40b is turned on.

When the bypass path for bypassing the LED 40b is turned on, electric charges accumulated in the capacitor 31b are released. The current generated by these electric charges flows in a closed circuit that is formed of the capacitor 31b, the thyristor 34b and the resistor 32b (see the waveforms of the currents I13b and I34b in FIG. 27) but does not flow in the normal LED 40a (see the waveform of the current I40a in FIG. 25).

Now, the operation of the LED 40a when the thyristor 34b is conductive will be described. Immediately after an open-circuit failure has occurred in the LED 40b, current flows through the capacitor 31b (see the waveform of the current I31b in FIG. 26). Therefore, the normal LED 40a is kept at a lighted state even during a time period after the open-circuit failure has occurred in the LED 40b until the thyristor 34b is conductive (see the waveform of the current I40a in FIG. 25).

Next, a time period required until the current detection unit 300b turns the thyristor 34b to be conductive after the open-circuit failure has occurred in the LED 40b will be discussed below. The period of the pulsation of the current I31b flowing in the capacitor 31b shown in FIGS. 25 and 26 corresponds to the switching period of the FET 24 of the constant-current circuit 20. Further, as shown in FIG. 26, the current I31b exceeds the threshold Ith until the current I31b reaches the peak of its pulsation after the open-circuit failure has occurred in the LED 40b and then the DC component is added to the current I31b. Accordingly, the detection time can be reduced below the period of the pulsation of the current I31b, i.e., below the switching period of the FET 24. By doing so, the thyristor 34b can become conductive with a less amount of electric charges accumulated in the capacitor 31b. Accordingly, excessive current to be generated at the instant when the thyristor 34b becomes conductive can be suppressed, so that stress to be exerted on the bypass circuits 30a and 30b can be suppressed.

As described above, the lighting device 1a according to the fifth embodiment includes: the constant-current circuit 20 that supplies a constant current to the plurality of LEDs 40a and 40b connected in series; the capacitor circuits 37a and 37b connected in parallel to the LEDs 40a and 40b, respectively; the thyristors 34a and 34b connected in parallel to the capacitor circuits 37a and 37b, respectively; and the current detection units 300a and 300b configured to measure currents flowing through the capacitors 31a and 31b, respectively. The current detection units 300a and 300b turn on the thyristors 34a and 34b, respectively, when the measured currents exceed the predetermined threshold Ith.

In this manner, immediately after the thyristors 34a or 34b serving as bypass switches become conductive, the current from the capacitor 31a or 31b does not flow in the normal LED, and thus stress exerted on the normal LED is mitigated. In addition, according to the fifth embodiment, even during the time period after an open-circuit failure has occurred in one of the LEDs 40a and 40b until the bypass switch is turned on, current flows in the other one of the LEDs 40a and 40b so that the other one of the LEDs 40a and 40b is kept at a lighted state.

Further, the lighting device 1a according to the fifth embodiment may include the resistors 32a and 32b connected in series to the capacitors 31a and 31b, respectively. The current detection units 300a and 300b may measure the currents flowing through the capacitors 31a and 31b based on the voltages across the resistors 32a and 32b, respectively.

By doing so, the current detection units 300a and 300b of the lighting device 1a can accurately measure the currents flowing through the capacitors 31a and 31b, respectively.

Furthermore, in the lighting device 1a according to the fifth embodiment, the constant-current circuit 20 is a DC-to-DC converter that is controlled in a BCM manner. The predetermined threshold Ith is larger than the output current of the constant-current circuit 20 and is equal to or less than two times the output current.

By doing so, the threshold Ith can be set so that an open-circuit failure in the LED 40a or 40b can be detected.

### Sixth Embodiment

Next, a lighting device according to the sixth embodiment will be described.

The basic elements and operations of the lighting device according to the sixth embodiment are identical to those according to the fifth embodiment except for the configuration of the current detection unit. Therefore, descriptions will be made focusing on the differences between the fifth and sixth embodiments.

According to the above fifth embodiment, when the lighting device 1a undergoes a transitional behavior such as start-up, large currents flow in the capacitors 31a and 31b, and thus the current detection units 300a and 300b may malfunction.

In this regard, according to the sixth embodiment, there is provided a lighting device capable of suppressing such malfunction of the current detection units.

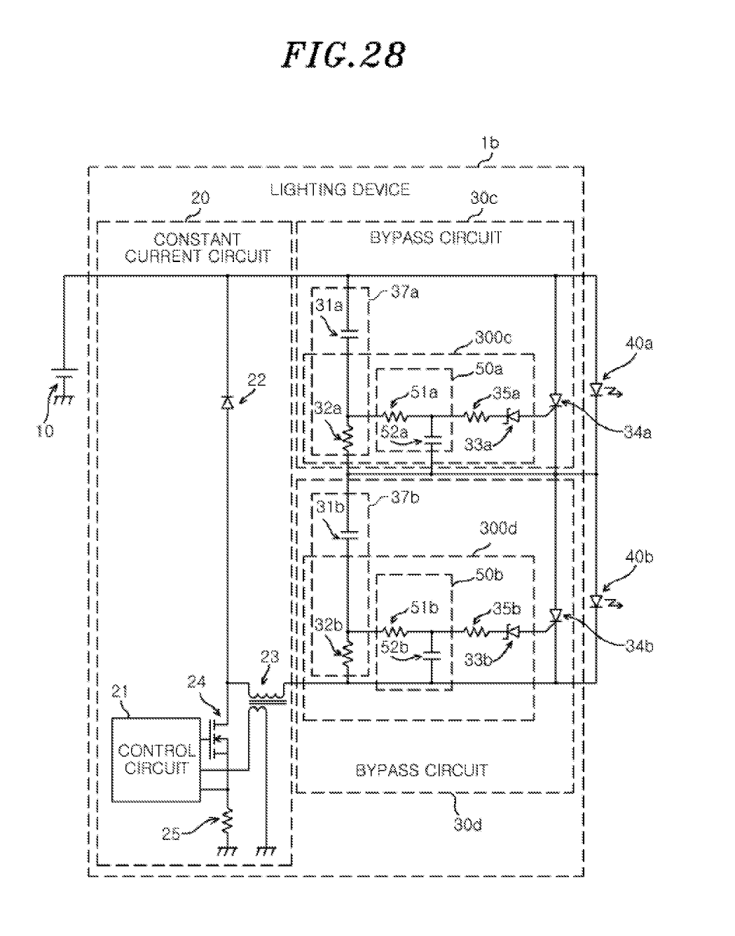

At first, elements of a lighting device according to the sixth embodiment will be described with reference to FIG. 28.

FIG. 28 is a circuit diagram of a lighting device according to the sixth embodiment of the present invention.

As can be seen from FIG. 28, the lighting device 1b according to the sixth embodiment is different in the configurations of the current detection unit 300c of the bypass circuit 30c and the current detection unit 300d of the bypass circuit 30d, compared to the lighting device 1a according to the fifth embodiment. In the lighting device 1b, the current detection unit 300c has therein a RC (resistor-capacitor) filter 50a and a resistor 35a, and the current detection unit 300d has therein a RC filter 50b and a resistor 35b.

The RC filters 50a and 50b are high-cut filters that attenuate high-frequency components in voltage applied to cathodes of zener diodes 33a and 33b, respectively. The RC filter 50a includes a resistor 51a and a capacitor 52a. The RC filter 50b includes a resistor 51b and a capacitor 52b. The resistors 35a and 35b are resistors for preventing malfunction of the current detection units 300c and 300d by limiting current flowing in the thyristors 34a and 34b, respectively.

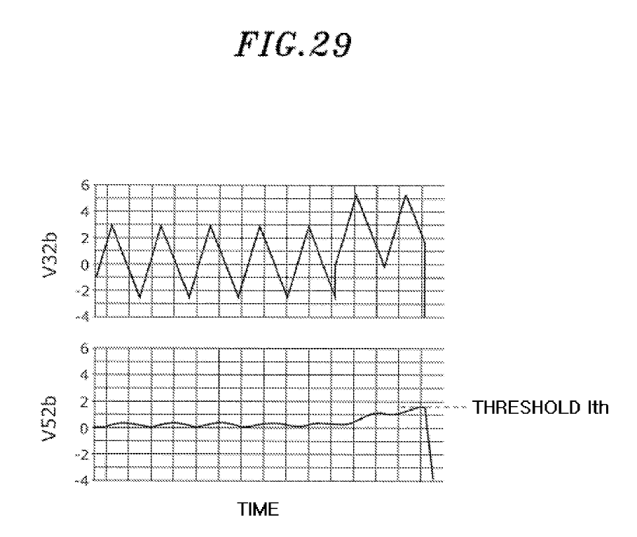

Next, the operation of the lighting device 1b according to the sixth embodiment will be described with reference to FIG. 29.

FIG. 29 shows graphs of waveforms of a voltage V32b across the resistor 32b and a voltage V52b across the capacitor 52b versus time, when an open-circuit failure occurs in the LED 40b.

As shown in FIG. 29, the pulsation, which is high-frequency component, in the voltage across the resistor 32b is suppressed by the RC filter 50b. Therefore, the current detection units 300c and 300d can detect the DC component in the current flowing in the capacitors 31a and 31b, respectively, other than the high-frequency component. According to the sixth embodiment, the zener diodes 33a and 33b are chosen so that the voltages applied to the zener diodes 33a and 33b exceeds their zener voltages, respectively, when the DC component in the current flowing in the capacitors 31a and 31b exceeds the threshold Ith.

As described above, in the lighting device 1b according to the sixth embodiment, the current detection units 300c and 300d include RC filters 50a and 50b that attenuate high-frequency components in the current. Further, the current detection units 300c and 300d detect the DC component in the current flowing in the capacitors 31a and 31b, respectively.

In this manner, the lighting device 1b according to the sixth embodiment can suppress the malfunction of the current detection units 300c and 300d due to a transitional behavior such as start-up and the like.

In addition, the lighting device 1b according to the sixth embodiment includes resistors 35a and 35b for preventing malfunction.

With the resistors 35a and 35b, in the lighting device 1b according to the sixth embodiment, currents flowing in the thyristors 34a and 34b are suppressed, so that malfunction of the thyristors 34a and 34b can be suppressed.

### Seventh Embodiment

Next, a lighting device according to the seventh embodiment will be described.

The basic elements and operations of the lighting device according to the seventh embodiment are identical to those according to the fifth embodiment except for the configuration of the bypass circuit. Therefore, descriptions will be made focusing on the differences between the fifth and seventh embodiments.

In the lighting device 1a according to the above fifth embodiment, excessive currents flows in the bypass circuits 30a and 30b immediately after the bypass circuits 30a and 30b operate, respectively (see the waveforms of the currents I31b and I34b shown in FIG. 27). Consequently, stress may be exerted on the thyristors 34a and 34b of the bypass circuits 30a and 30b, or the like.

In this regard, according to the seventh embodiment, there is provided a lighting device capable of suppressing excessive current flowing immediately after the bypass circuits operate.

At first, elements of a lighting device according to the seventh embodiment will be described with reference to FIG. 30.

FIG. 30 is a circuit diagram of a lighting device according to the seventh embodiment of the present invention.

As can be seen from FIG. 30, the lighting device 1c according to the seventh embodiment is different from the lighting device 1a according to the fifth embodiment in the configurations of the bypass circuits 30e and 30f.

According to the seventh embodiment, the bypass circuit 30e has therein an impedance element 60a and a diode 36a, and the bypass circuit 30f has therein an impedance element 60b and a diode 36b.

The impedance elements 60a and 60b are connected in series to the thyristors 34a and 34b, respectively. The impedance element 60a and the thyristor 34a form a bypass switch circuit 38a and the bypass switch circuit 38a is connected in parallel to the LED 40a. Likewise, the impedance element 60b and the thyristor 34b form a bypass switch circuit 38b and the bypass switch circuit 38b is connected in parallel to the LED 40b.

The impedance elements 60a and 60b suppress currents flowing in the bypass circuits 30e and 30f immediately after the bypass circuits 30e and 30f operate. The impedance element 60a includes a thermistor 61a and an inductor 62a. The impedance element 60b includes a thermistor 61b and an inductor 62b.

The thermistors 61a and 61b are NTC (negative temperature coefficient) thermistors whose resistance decreases with increase of temperature. The thermistors 61a and 61b have high resistance at a low temperature. Therefore, when the current is zero and the temperature is low, the thermistors 61a and 61b can suppress the current from increasing abruptly.

The inductors 62a and 62b are elements that resist change in current, and thus they can suppress the current from increasing abruptly. Further, the resistance of the inductors 62a and 62b is almost zero, if there is no change in current. Therefore, in the operation of the bypass circuits 30e and 30f, when currents flowing in the thyristors 34a and 34b become constant, currents flow in the inductors 62a and 62b and thus loss can be reduced.

The diodes 36a and 36b are connected in parallel to the LEDs 40a and 40b, respectively, and suppress oscillation of current caused by the inductors 62a and 62b.

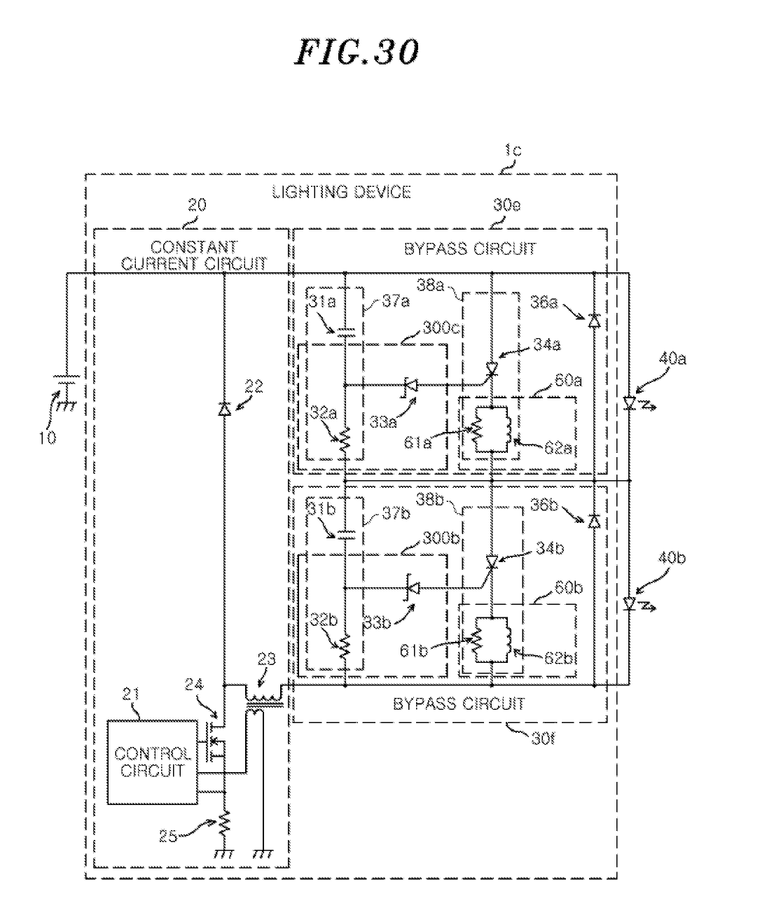

Next, the operation of the lighting device 1c according to the seventh embodiment will be described with reference to FIG. 31.

FIG. 31 shows graphs of waveforms of the currents I31b and I34b flowing in the capacitor 31b and the thyristor 34b, respectively, versus time in the case where an open-circuit failure occurs in the LED 40b, according to the fifth and seventh embodiment.

As shown in FIG. 31, according to the fifth embodiment, when an open-circuit failure occurs in the LED 40b, the bypass circuit 30b operates, and immediately thereafter, the current increases abruptly. On the other hand, according to the seventh embodiment, the current also increases immediately after the bypass circuit 30f operates, but the peak value of the current is significantly reduced.

As described above, the lighting device 1c according to the seventh embodiment includes the impedance elements 60a and 60b which are connected in series to the thyristors 34a and 34b serving as bypass switches, respectivelys.

With the impedance elements 60a and 60b, it is possible to suppress abrupt increase in current immediately after the bypass circuits 30e and 30f operate. In addition, in a normal operation state, the bypass circuits 30e and 30f allow current to flow in the inductors 62a and 62b, so that the loss can be reduced.

The lighting device 1c according to the seventh embodiment further includes the diodes 36a and 36b which are connected in parallel to the LEDs 40a and 40b, respectively.

With the diodes 36a and 36b, it is possible to suppress oscillation of current caused by the inductors 62a and 62b.

### Eighth Embodiment

Next, a lighting device according to the eighth embodiment will be described.

The basic elements and operations of the lighting device according to the eighth embodiment are identical to those according to the fifth embodiment except for the configuration of the bypass circuit. Therefore, descriptions will be made focusing on the differences between the fifth and eighth embodiments.

According to the eighth embodiment, there is provided a lighting device capable of more accurately detecting current than the lighting device 1a of the fifth embodiment.

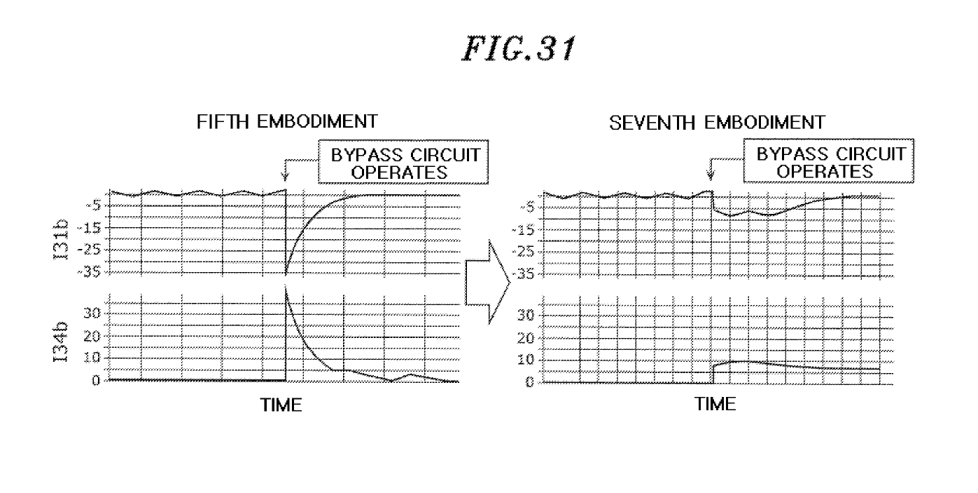

At first, elements of a lighting device according to the eighth embodiment will be described with reference to FIG. 32.

FIG. 32 is a circuit diagram of a lighting device according to the eighth embodiment of the present invention.

As can be seen from FIG. 32, the lighting device 1d according to the eighth embodiment is different in the configurations of a bypass circuit 30g from the lighting device 1a of the fifth embodiment. The bypass circuit 30g includes an MCU (micro-control unit) 71a, photo-couplers 74a and 74b, MOSFETs (metal oxide semiconductor field effect transistors) 73a and 73b, and gate resistors 72a and 72b.

The MCU 71a of the bypass circuit 30g is a processing unit that measures currents flowing in the capacitors 31a and 31b to output signals corresponding to the measured currents to the photo-couplers 74a and 74b. The MCU 71a measures currents flowing in the capacitors 31a and 31b based on the voltages across the resistors 32a and 32b, respectively.

The MOSFETs 73a and 73b of the bypass circuit 30g are bypass switches. When a high voltage is applied between gate and source of the MOSFETs 73a and 73b, source-drain channel becomes conductive.

The photo-couplers 74a and 74b of the bypass circuit 30g are elements that transfer electrical signals by using light. The photo-couplers 74a and 74b transfer signals from the MCU 71a to the MOSFETs 73a and 73b, respectively. Output signals from the MCU 71a are inputted to the input circuit sides of the photo-couplers 74a and 74b. If the output signals from the MCU 71a are at high level, the output circuit sides of the photo-couplers 74a and 74b become conductive. If the output signals from the MCU 71a are at low level, the output circuit sides of the photo-couplers 74a and 74b is not conductive. Since the MCU 71a and the MOSFETs 73a and 73b are electrically isolated by the photo-couplers 74a and 74b, noise cannot be transmitted.

According to the eighth embodiment, the current detection unit that detects currents flowing in the capacitors 31a and 31b includes the MCU 71a, the resistors 32a and 32b, and the photo-couplers 74a and 74b.

Next, the operation of the bypass circuit 30g according to the eighth embodiment will be described. As an example of the operations, a scenario where an open-circuit failure occurs in the LED 40b will be described.

Similar to the above-described fifth to seventh embodiments, if an open-circuit failure occurs in the LED 40b, the DC component is added to the current flowing in the capacitor 31b, and accordingly the current flowing in the capacitor 31b rises. If the current flowing in the capacitor 31b rises, the MCU 71a measures the voltage across the resistor 32b. Further, the MCU 71 compares the measured value with a reference voltage value, by using a comparator provided therein, to determine whether the current flowing in the capacitor 31b exceeds the threshold Ith. The MCU 71a outputs a signal of high level to the photo-coupler 74b if the current I31b flowing in the capacitor 31b does not exceed the threshold Ith, whereas the MCU 71a outputs a signal of low level to the photo-coupler 74b if the current I31b exceeds the threshold Ith. The output circuit side of the photo-coupler 74b becomes conductive when a signal of high level is received from the MCU 71a. The output circuit side of the photo-coupler 74b is not conductive when a signal of low level is received from the MCU 71a. Accordingly, when the current I31b exceeds the threshold Ith, the level of the gate-source voltage of the MOSFET 73b becomes high, so that the source-drain channel becomes conductive. Consequently, a bypass path for bypassing the LED 40b is turned on. On the other hand, when the current I31b does not exceed the threshold Ith, the level of the gate-source voltage of the MOSFET 73b becomes low, so that the source-drain channel does not become conductive.

As described above, similar to the fifth embodiment, the lighting device 1d according to the eighth embodiment can turn on the bypass path when an open-circuit failure has occurred in one of the LEDs 40a and 40b, without causing excessive current to flow in the other one of the LEDs 40a and 40b. Further, according to the eighth embodiment, currents are measured by the MCU 71a, so that detection accuracy of the current can be improved. Furthermore, in order to prevent malfunction in a transitional state such as start-up of the lighting device 1d, software processing can be performed in the MCU. For example, a mask time period can be set so that the MOSFETs 73a and 73b of the bypass circuit 30g do not become conductive for a certain period of time after the start-up of the lighting device 1d. In addition, filtering process on a signal inputted to the MCU 71a can be performed by software, thereby preventing malfunction.

### Ninth Embodiment

Next, a lighting device according to the ninth embodiment will be described.

The basic elements and operations of the lighting device according to the ninth embodiment are identical to those according to the eighth embodiment except for the configuration of the bypass circuit. Therefore, descriptions will be made focusing on the differences between the fifth and ninth embodiments.

According to the above eighth embodiment, the currents flowing in the capacitors 31a and 31b of the bypass circuit 30g are measured based on the voltages across the resistors 32a and 32b, respectively. In contrast, according to the ninth embodiment, the currents are measured based on the voltages across the capacitors 31a and 31b.

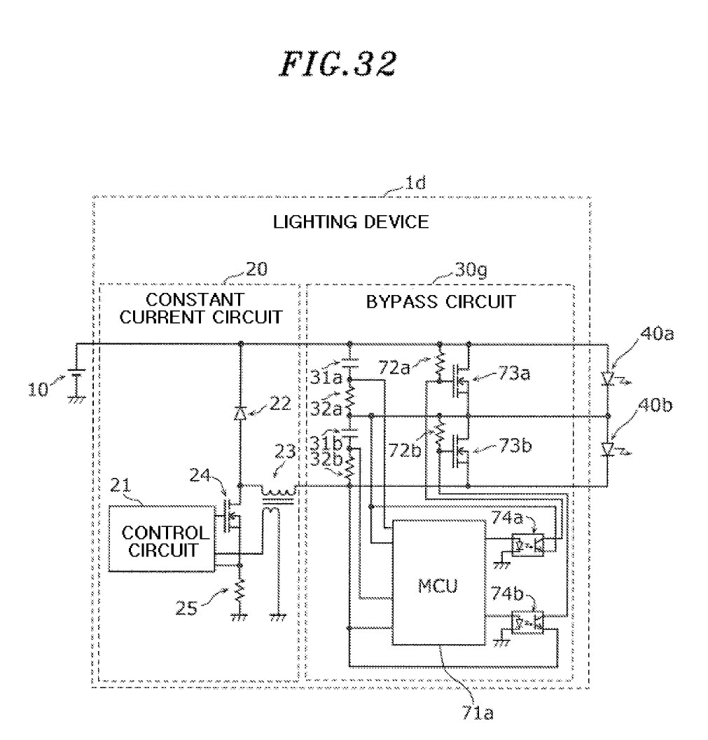

At first, elements of a lighting device according to the ninth embodiment will be described with reference to FIG. 33.

FIG. 33 is a circuit diagram of a lighting device according to the ninth embodiment of the present invention.

As can be seen from FIG. 33, the lighting device 1e according to the ninth embodiment is different from the lighting device 1d of the eighth embodiment in that the voltages across the capacitors 31a and 31b are measured by an MCU 71b of a bypass circuit 30h. Therefore, according to the ninth embodiment, the resistors 32a and 32b used for detecting current in the eighth embodiment are not required. In the ninth embodiment, the current detection unit that measures currents flowing in the capacitors 31a and 31b includes the MCU 71b and the photo-couplers 74a and 74b.

Next, the operation of the bypass circuit 30h in the lighting device 1e according to the ninth embodiment will be described. As an example of the operation, a scenario where an open-circuit failure occurs in the LED 40b will be described.

Similar to the fifth to eighth embodiments, if an open-circuit failure occurs in the LED 40b, the DC component is added to the current flowing in the capacitor 31b, and accordingly the current flowing in the capacitor 31b rises. As the current flowing in the capacitor 31b increases, the voltage across the capacitor 31b also increases. The MCU 71b measures the voltage across the capacitor 31b. Further, the MCU 71b compares the measured value with a reference voltage value by using a comparator provided therein to determine whether the current flowing in the capacitor 31b exceeds the threshold Ith. The subsequent operations by the MCU 71b, the photo-couplers 74a and 74b and the MOSFETs 73a and 73b are identical to those of the eighth embodiment.

As described above, the lighting device 1e according to the ninth embodiment can also achieve the same effect as that of the eighth embodiment.

### Tenth Embodiment

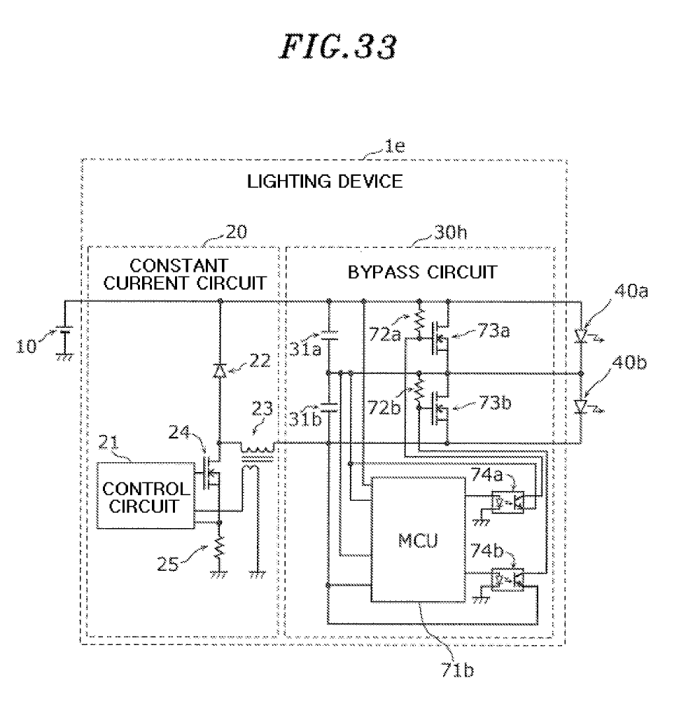

As the tenth embodiment, a luminaire having any one of the lighting devices 210a to 210e and 1a to 1e according to the first to the ninth embodiment will be described with reference to FIGS. 34 to 36. The luminaire includes light-emitting elements in addition to the lighting device.

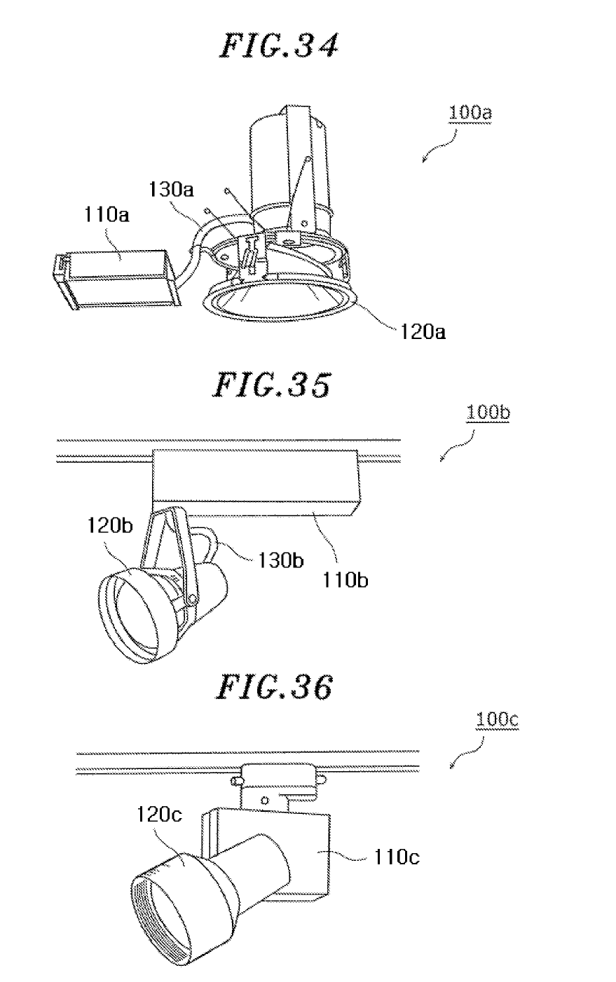

FIGS. 34 to 36 are external views of the luminaire having any one of the lighting devices 210a to 210e and 1a to 1e according to the first to the ninth embodiments. As examples of the luminaire, a downlight 100a (shown in FIG. 34) and spotlights 100b and 100c (shown in FIG. 35 and FIG. 36, respectively) are illustrated. In FIGS. 34 to 36, circuit boxes 110a to 110c accommodate a circuit of any one of the lighting devices 210a to 210e and 1a to 1e. The LEDs 40a and 40b or the LED 202a and 202b are installed in lamp bodies 120a to 120c. A wire 130a in FIG. 34 and a wire 130b in FIG. 35 electrically connect the circuit boxes 110a and 110b with the lamp bodies 120a and 120b, respectively.

The tenth embodiment can also achieve the same effects as those of the above-described first to ninth embodiments.

(Modification)

Thus far, the lighting devices and the luminaire of the present invention have been described based on the embodiments. However, the present invention is not limited to the embodiments.

For example, in the fifth to ninth embodiments, the two LEDs 40a and 40b are used as solid-state elements. However, three or more LEDs may be used, each with a capacitor and a bypass switch connected in parallel thereto.

Further, in the fifth to ninth exemplary embodiments, every solid-state light-emitting element is provided with a bypass circuit. However, at least one of the solid-state light-emitting elements may be provided with a bypass circuit. In this instance, an additional smoothing capacitor may be provided between output terminals of the constant-current circuit 20.

Further, in the lighting devices 1a to 1c according to the fifth to seventh embodiments, the zener diodes 33a and 33b are used in the current detection units 300a to 300d. However, the zener diodes 33a and 33b may not be included the current detection units 300a to 300d. In other words, two ends of each of the zener diodes 33a and 33b may be short-circuited. In the case where the zener diodes 33a and 33b are not employed, however, it is necessary to set characteristics of elements so that the thyristors 34a and 34b become conductive by the currents flowing to the gate electrodes of the thyristors 34a and 34b when the currents flowing in the capacitors 31a and 31b exceeds the threshold Ith.

In the fifth to ninth embodiments, the LEDs 40a and 40b are used as the solid-state light-emitting elements. However, organic EL (Electro-Luminescence) elements may be used.

In the fifth to ninth embodiments, the thyristors 34a and 34b or the MOSFETs 73a and 73b are used as the bypass switches. However, other switching elements may be used as well. For example, switching transistors other than MOSFETs may be used.

The constant-current circuit 20 according to the fifth to ninth embodiments may be replaced with another constant-current circuit, e.g., the constant-current circuit 212 shown in FIG. 19, FIG. 22 or FIG. 23.

Further, in the fifth to ninth embodiments, the DC-to-DC converter that performs BCM control is used as the constant-current circuit 20. However, a DC-to-DC converter that performs CCM (continuous current mode) control may be used.

Thus far, the lighting devices of the present invention have been described based on the first to ninth embodiments. However, the present invention is not limited to those embodiments. Aspects implemented by adding a variety of modifications conceived by those skilled in the art to the embodiments or aspects implemented by combining elements in different embodiments also fall within the scope of one or more aspects of the present invention, as long as they do not depart from the gist of the present invention.

In addition, at least a part of the processing units included in the lighting devices according to the first to ninth embodiments may be implemented as an LSI (large-scale integration), which is an integrated circuit. Each of them may be implemented as one chip or some or the whole of them may be implemented as one chip.

The integrated circuit is not limited to an LSI, but may be implemented by a dedicated circuit or a general-purpose processor. A FPGA (field programmable gate array) that can be programmed after an LSI manufacturing, or a reconfigurable processor capable of reconstructing the setting and connections of circuit cells in the LSI may be used.

A part or the whole of the elements in the first to ninth embodiments may be implemented with dedicated hardware or may be implemented by executing software programs appropriate for the elements. The elements may be implemented in a such manner that a program executing unit such as a CPU and a processor reads out a software program stored in a storage medium such as a hard disk and a semiconductor memory to execute it.

In the block diagrams, the division of the functional blocks is merely illustrative. Several functional blocks may be implemented as a single functional block or a single functional block may be divided into several functional blocks. Further, some of functionalities in a functional block may be performed by another functional block. Additionally, similar functionalities of several functional bocks may be performed by single hardware or software in parallel manner or in a time-divisional manner.

The orders in which the steps of the processes are carried out are merely illustrative, and therefore the steps may be carried out in other orders. In addition, some of the steps may be carried out simultaneously (in parallel) with other steps.

The circuit configurations shown in the circuit diagrams are merely illustrative and the present invention is not limited to the circuit configurations. In other words, any circuit that can implement the features of the present disclosure like the above-described circuit configurations is also within the scope of the present disclosure. For example, as long as the same functionality as the above-described circuit configurations is implemented, connecting, in series or in parallel, a switching element (transistor), a resistor or a capacitive element to a particular element is also within the scope of the present invention. In other words, in the above embodiments, a term “connected” refers to not only that two terminals (nodes) are directly connected to each other but also that the two terminals (nodes) are connected to each other through another element, as long as the same functionality is implemented.

The numerical values given above are merely illustrative and the present disclosure is not limited to those values. Further, the logic levels represented as High and Low, and the switching states represented as On and Off are merely illustrative. It is also possible to achieve the same result by using combinations of logic levels or switching states different from those described above. Further, the configurations of the logic circuits described above are merely illustrative. It is also possible to achieve the equal input/output relationship by using different configurations of logic circuits.

While the invention has been shown and described with respect to the embodiments, it will be understood by those skilled in the art that various changes and modifications may be made without departing from the scope of the invention as defined in the following claims.

What is claimed is:

1. A lighting device, comprising:
a constant-current circuit configured to supply a constant current to a plurality of solid-state light-emitting elements connected in series;
a smoothing capacitor connected between output terminals of the constant-current circuit;
a bypass circuit connected in parallel to one or more of the plurality of solid-state light-emitting elements, the bypass circuit configured to bypass the one or more solid-state light-emitting elements;
a detection unit configured to detect whether the one or more solid-state light-emitting elements are open-circuited; and
a bypass control unit configured to, when the detection unit detects that at least one of the one or more solid-state light-emitting elements is open-circuited, discharge the smoothing capacitor during a discharge period to then bypass the one or more solid-state light-emitting elements through the bypass circuit.

2. The lighting device of claim 1, wherein, during the discharge period, the smoothing capacitor is discharged until a voltage across the smoothing capacitor becomes smaller than a sum of forward voltages of the plurality of solid-state light-emitting elements.

3. The lighting device of claim 2, wherein, during the discharge period, the smoothing capacitor is discharged until the voltage across the smoothing capacitor becomes smaller than a sum of forward voltages of other solid-state light-emitting elements than the one or more solid-state light-emitting elements among the plurality of solid-state light-emitting elements.

4. The lighting device of claim 1, wherein, during the discharge period, the bypass control unit stops the constant-current circuit or reduces a value of the constant current supplied from the constant-current circuit.

5. The lighting device of claim 1, further comprising:
a discharge circuit connected in parallel to the smoothing capacitor,
wherein, during the discharge period, the bypass control unit turns on the discharge circuit to discharge the smoothing capacitor.

6. The lighting device of claim 1, wherein the bypass control unit includes a comparator to compare a voltage across the smoothing capacitor with a predetermined reference voltage, and
wherein the bypass control unit terminates the discharge period when the voltage across the smoothing capacitor becomes lower than the reference voltage, and bypasses the one or more solid-state light-emitting elements through the bypass circuit.

7. The lighting device of claim 1, wherein, after the detection unit detects that said at least one of the one or more solid-state light-emitting elements is open-circuited, the bypass control unit terminates the discharge period after a predetermined time period has elapsed and bypasses the one or more solid-state light-emitting elements through the bypass circuit.

8. The lighting device of claim 7, wherein the discharge period is longer than a time constant of a discharge path through which the smoothing capacitor is discharged.

9. The lighting device of claim 1, wherein the constant-current circuit is a DC-to-DC converter that is supplied with a current from a DC power source, and
wherein the constant-current circuit includes:
a switching element;
an inductor through which the current from the DC power source flows when the switching element is turned on;
a diode through which a current discharged from the inductor is supplied to the plurality of solid-state light-emitting elements; and
a control unit for controlling on and off of the switching element.

10. A luminaire, comprising:
a plurality of solid-state light-emitting elements; and
a lighting device including:
a constant-current circuit configured to supply a constant current to the plurality of solid-state light-emitting elements connected in series;
a smoothing capacitor connected between output terminals of the constant-current circuit;
a bypass circuit connected in parallel to one or more of the plurality of solid-state light-emitting elements, the bypass circuit configured to bypass the one or more solid-state light-emitting elements;
a detection unit configured to detect whether the one or more solid-state light-emitting elements are open-circuited; and
a bypass control unit configured to, when the detection unit detects that at least one of the one or more solid-state light-emitting elements is open-circuited, discharge the smoothing capacitor during a discharge period to then bypass the one or more solid-state light-emitting elements through the bypass circuit.

11. A lighting device, comprising:
a constant-current circuit configured to supply a constant current to a plurality of solid-state light-emitting elements connected in series;
a capacitor circuit connected in parallel to one or more of the plurality of solid-state light-emitting elements, the capacitor circuit including a capacitor;
a bypass switch circuit connected in parallel to the one or more solid-state light-emitting elements and to the capacitor circuit, the bypass switch circuit including a bypass switch; and
a current detection unit configured to measure a current flowing through the capacitor,
wherein the current detection unit turns on the bypass switch when the measured current exceeds a predetermined threshold.

12. The lighting device of claim 11, wherein the capacitor circuit further includes a resistor connected in series to the capacitor, and
wherein the current detection unit measures the current based on a voltage across the resistor.

13. The lighting device of claim 11, wherein the current detection unit includes a resistor-capacitor filter to attenuate high-frequency components in the current.

14. The lighting device of claim 11, wherein the bypass switch circuit further includes an impedance element connected in series to the bypass switch.

15. The lighting device of claim 11, wherein the constant-current circuit is a DC-to-DC converter that is supplied with a current from a DC power source, and
wherein the constant-current circuit includes:
a switching element;
a control circuit that outputs a signal to control on and off of the switching element;
an inductive element through which the current from the DC power source flows when the switching element is turned on; and
a diode through which a current discharged from the inductive element is supplied to the plurality of solid-state light-emitting elements.

16. The lighting device of claim 15, wherein the current detection unit detects a DC component in the current flowing through the capacitor.

17. The lighting device of claim 15, wherein the constant-current circuit is driven in a boundary current mode, and the predetermine threshold is larger than a value of the constant current supplied from the constant-current circuit and is equal to or less than two times the value.

18. A luminaire, comprising:
a plurality of solid-state light-emitting elements; and
a lighting device including:
a constant-current circuit configured to supply a constant current to a plurality of solid-state light-emitting elements connected in series;
a capacitor circuit connected in parallel to one or more of the plurality of solid-state light-emitting elements, the capacitor circuit including a capacitor;
a bypass switch circuit connected in parallel to the one or more solid-state light-emitting elements and to the capacitor circuit, the bypass switch circuit including a bypass switch; and
a current detection unit configured to measure a current flowing through the capacitor,
wherein the current detection unit turns on the bypass switch when the measured current exceeds a predetermined threshold.
